(19) United States
(12) Patent Application Publication
(10) Pub. No.: US 2012/0294584 A1
(43) Pub. Date: Nov. 22, 2012

(54) REPRODUCING DEVICE, METHOD OF REPRODUCING STREAM FILE, AND PROGRAM

(75) Inventor: Takeshi Takeuchi, Tokyo (JP)

(73) Assignee: SONY CORPORATION, Tokyo (JP)

(21) Appl. No.: 13/468,277

(22) Filed: May 10, 2012

(30) Foreign Application Priority Data
May 17, 2011 (JP) 2011-110309

(51) Int. Cl. H04N 5/93

(52) U.S. Cl. 386/241; 386/E05.028

(57) ABSTRACT

There is provided a reproducing device including a stream acquiring unit that acquires a stream file, a stream dividing unit that divides the stream file to be appropriate for a predetermined play list and a predetermined clip information file and generates a division stream file, and a stream reproducing unit that reproduces the division stream file based on the predetermined play list and the predetermined clip information file.

### BACKGROUND

The present technology relates to a reproducing device, a method of reproducing a stream file, and a program.

Service for distributing contents such as a moving image in a streaming manner have been widely used. As one of techniques used to provide such services, there is a technique called progressive download reproduction. Progressive download reproduction refers to a technique for reproducing downloaded stream files in order while sequentially downloading stream files configuring content. With respect to progressive download reproduction, Japanese Patent No. 4444358 discloses a technique for adding padding data of an amount corresponding to a difference of a data amount to a stream file when a data amount of a downloaded stream file is smaller than a data amount described in a reproduction management file.

### SUMMARY

Meanwhile, a stream file that conforms to a Blu-ray Disc (hereinafter, “BD”) standard is associated with a play item and a clip information file in a one-to-one manner. In order to reproduce a stream file associated with a new play item and a clip information file, a reproducing device such as a BD player executes a process for recognizing the play item and the clip information file. However, this process causes a high load in the reproducing device such as the BD player. For this reason, it takes a certain amount of time until this process is completed. As a result, an unpleasant standby time occurs when new content is reproduced.

In this regard, the present technology is made in light of the foregoing, and it is desirable to provide a reproducing device, a method of reproducing a stream file, and a program, which are novel and improved and capable of quickly starting reproduction of content when reproducing new content.

According to an embodiment of the present disclosure, there is provided a reproducing device which includes a stream acquiring unit that acquires a stream file, a stream dividing unit that divides the stream file to be appropriate for a predetermined play list and a predetermined clip information file and generates a division stream file, and a stream reproducing unit that reproduces the division stream file based on the predetermined play list and the predetermined clip information file.

According to another embodiment of the present disclosure, there is provided a method of generating a stream file which includes acquiring a stream file, dividing the stream file to be appropriate for a predetermined play list and a predetermined clip information file and generating a division stream file, and reproducing the division stream file based on the predetermined play list and the predetermined clip information file.

According to still another embodiment of the present disclosure, there is provided a program for causing a computer to execute a stream acquiring function of acquiring a stream file, a stream dividing function of dividing the stream file to be appropriate for a predetermined play list and a predetermined clip information file and generating a division stream file, and a stream reproducing function of reproducing the division stream file based on the predetermined play list and the predetermined clip information file. According to still another embodiment of the present disclosure, there is provided a computer readable recording medium recording the program.

According to the embodiments of the present technology, it is possible to quickly start reproduction of content even when reproducing new content.

### BRIEF DESCRIPTION OF THE DRAWINGS

FIG. 1 is an explanatory diagram illustrating a configuration example of a streaming distribution system;

FIG. 2 is an explanatory diagram illustrating a configuration of a reproduction management file;

FIG. 3 is an explanatory diagram illustrating a configuration of a reproduction management file;

FIG. 4 is an explanatory diagram for describing the flow of a process related to progressive download reproduction using a virtual package construction function;

FIG. 5 is an explanatory diagram for describing the flow of a process related to progressive download reproduction using a virtual package construction function;

FIG. 6 is an explanatory diagram for describing the flow of a process related to progressive download reproduction using a virtual package construction function;

FIG. 7 is an explanatory diagram for describing the flow of a process related to progressive download reproduction using a virtual package construction function;

FIG. 8 is an explanatory diagram for describing the flow of a process related to progressive download reproduction using a virtual package construction function;

FIG. 9 is an explanatory diagram for describing the flow of a process related to progressive download reproduction using an existing virtual package;

FIG. 10 is an explanatory diagram for describing the flow of a process related to progressive download reproduction using an existing virtual package;

FIG. 11 is an explanatory diagram for describing the flow of a process related to progressive download reproduction using an existing virtual package;

FIG. 12 is an explanatory diagram illustrating a configuration example of a reproducing device according to an embodiment;

FIG. 13 is an explanatory diagram for describing the flow of a progressive download reproduction process according to an embodiment;

FIG. 14 is an explanatory diagram for describing the flow of a progressive download reproduction process according to an embodiment;

FIG. 15 is an explanatory diagram for describing the flow of a progressive download reproduction process according to an embodiment;

FIG. 16 is an explanatory diagram for describing the flow of a progressive download reproduction process according to an embodiment;

FIG. 17 is an explanatory diagram for describing the flow of a progressive download reproduction process according to an embodiment;

FIG. 18 is an explanatory diagram for describing the flow of a progressive download reproduction process according to an embodiment;

FIG. 19 is an explanatory diagram for describing the flow of a progressive download reproduction process according to an embodiment;

FIG. 20 is an explanatory diagram for describing the flow of a progressive download reproduction process according to an embodiment;

FIG. 21 is an explanatory diagram for describing the flow of a progressive download reproduction process according to an embodiment;

FIG. 22 is an explanatory diagram for describing the flow of a progressive download reproduction process according to an embodiment;

FIG. 23 is an explanatory diagram for describing the flow of a progressive download reproduction process according to an embodiment;

FIG. 24 is an explanatory diagram for describing the flow of a progressive download reproduction process according to an embodiment;

FIG. 25 is an explanatory diagram for describing the flow of a progressive download reproduction process according to an embodiment;

FIG. 26 is an explanatory diagram for describing the flow of a progressive download reproduction process according to an embodiment;

FIG. 27 is an explanatory diagram for describing the flow of a progressive download reproduction process according to an embodiment;

FIG. 28 is an explanatory diagram for describing the flow of a progressive download reproduction process according to an embodiment;

FIG. 29 is an explanatory diagram for describing the flow of a progressive download reproduction process according to an embodiment;

FIG. 30 is an explanatory diagram for describing the flow of a progressive download reproduction process according to an embodiment;

FIG. 31 is an explanatory diagram for describing the flow of a progressive download reproduction process according to an embodiment;

FIG. 32 is an explanatory diagram for describing the flow of a progressive download reproduction process according to an embodiment;

FIG. 33 is an explanatory diagram for describing the flow of a progressive download reproduction process according to an embodiment;

FIG. 34 is an explanatory diagram for describing the flow of a progressive download reproduction process according to an embodiment;

FIG. 35 is an explanatory diagram for describing the flow of a progressive download reproduction process according to an embodiment;

FIG. 36 is an explanatory diagram for describing the flow of a progressive download reproduction process according to an embodiment; and

FIG. 37 is an explanatory diagram illustrating a hardware configuration example capable of implementing progressive download reproduction according to the present embodiment.

### DETAILED DESCRIPTION OF THE EMBODIMENT(S)

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

### [Regarding Flow of Description]

Here, the flow of the following description will be briefly described.

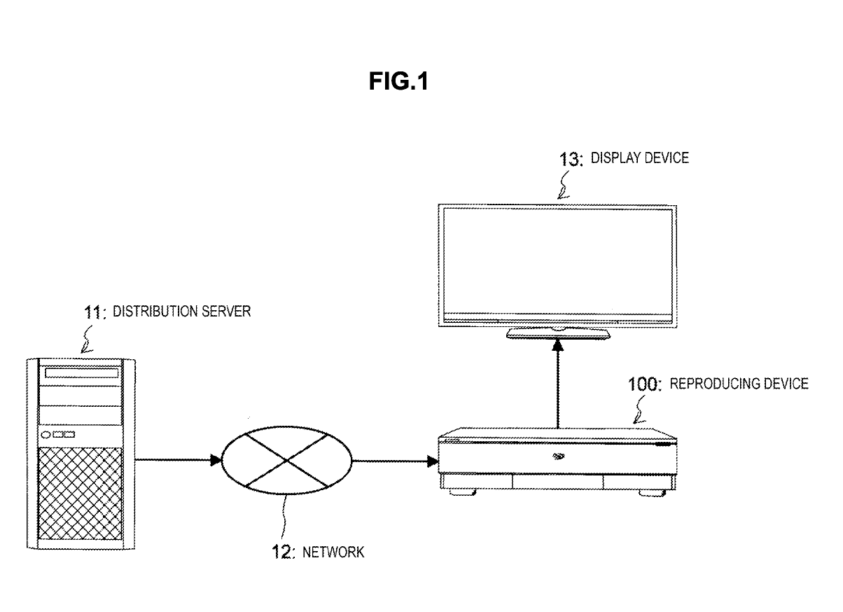

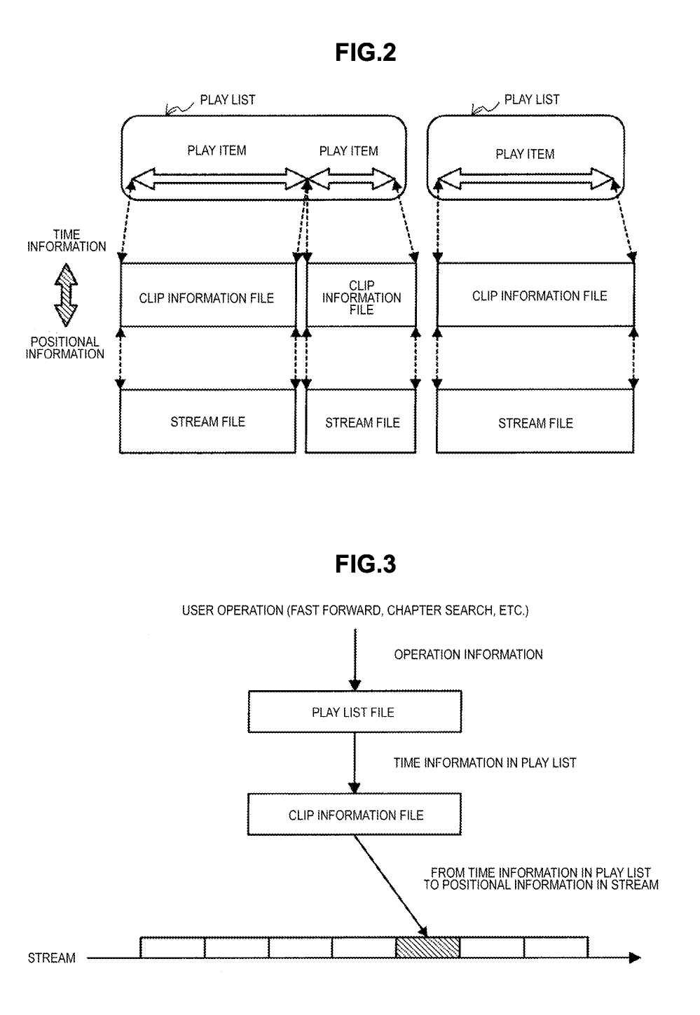

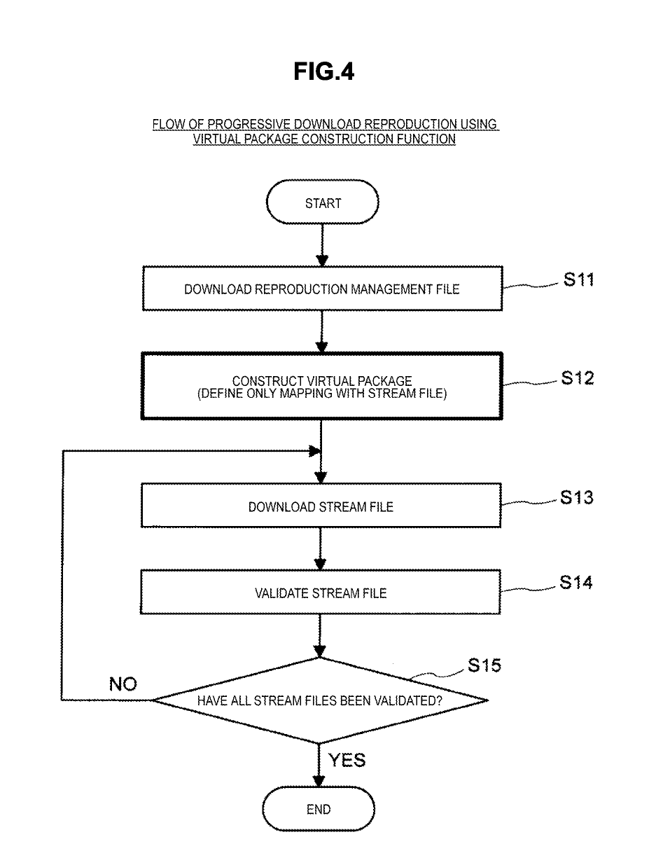

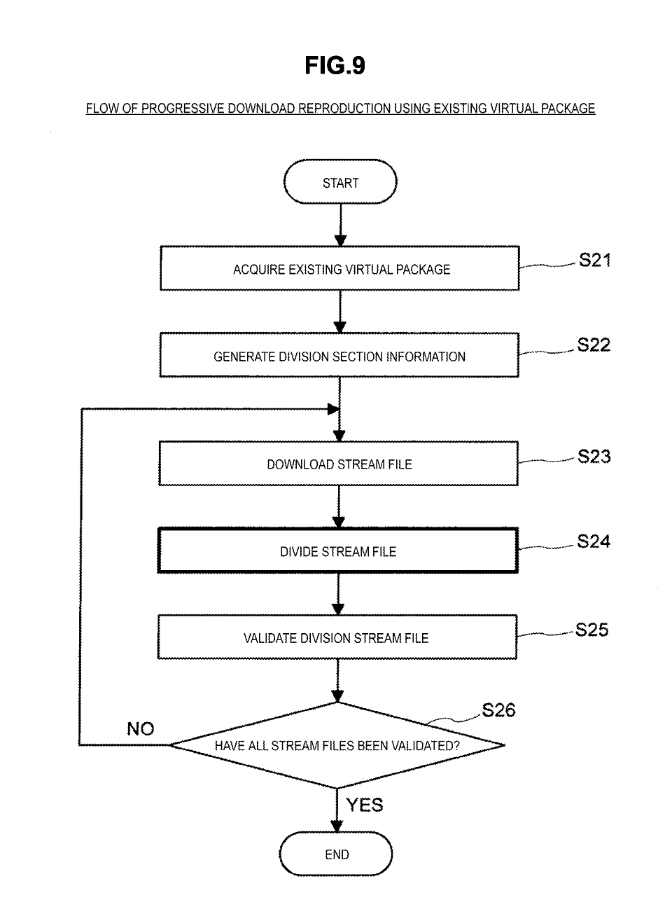

First, a configuration example of a streaming distribution system will be described with reference to FIG. 1. Next, a configuration of a reproduction management file will be described with reference to FIGS. 2 and 3. Next, the flow of a process related to progressive download reproduction using a virtual package construction function will be described with reference to FIGS. 4 to 8. Next, the flow of a process related to progressive download reproduction using an existing virtual package will be described with reference to FIGS. 9 to 11.

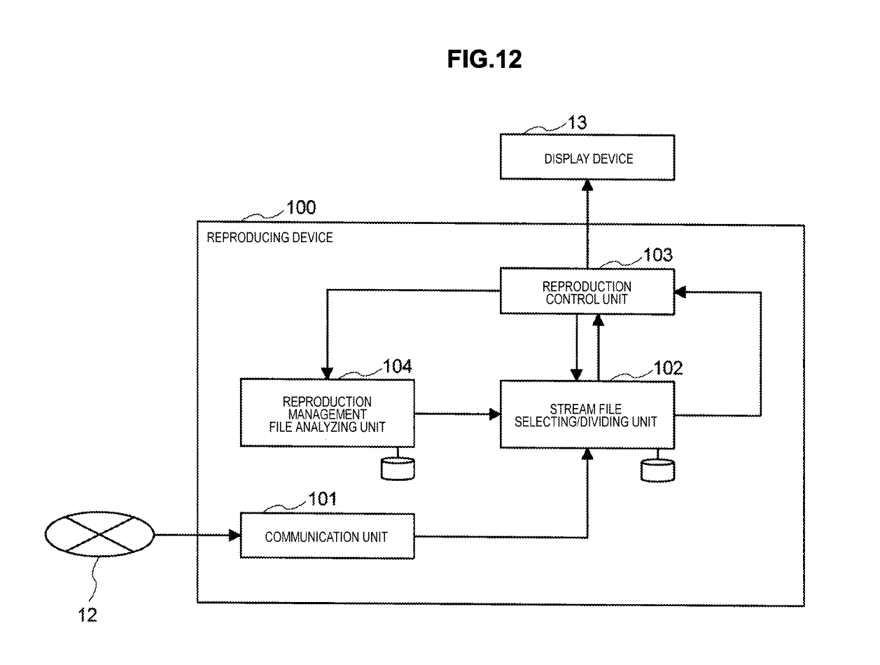

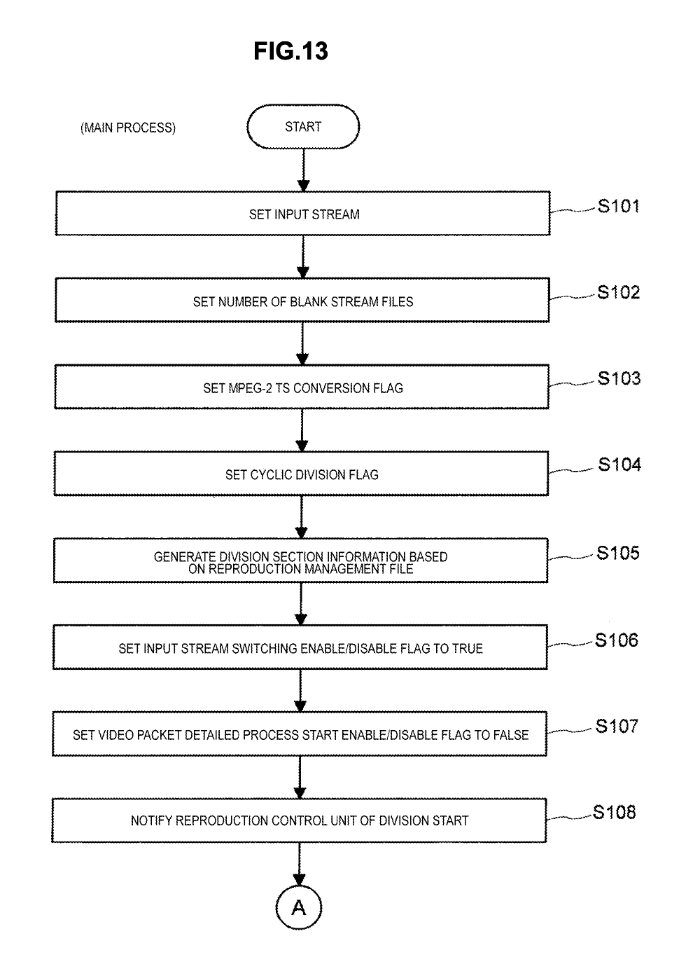

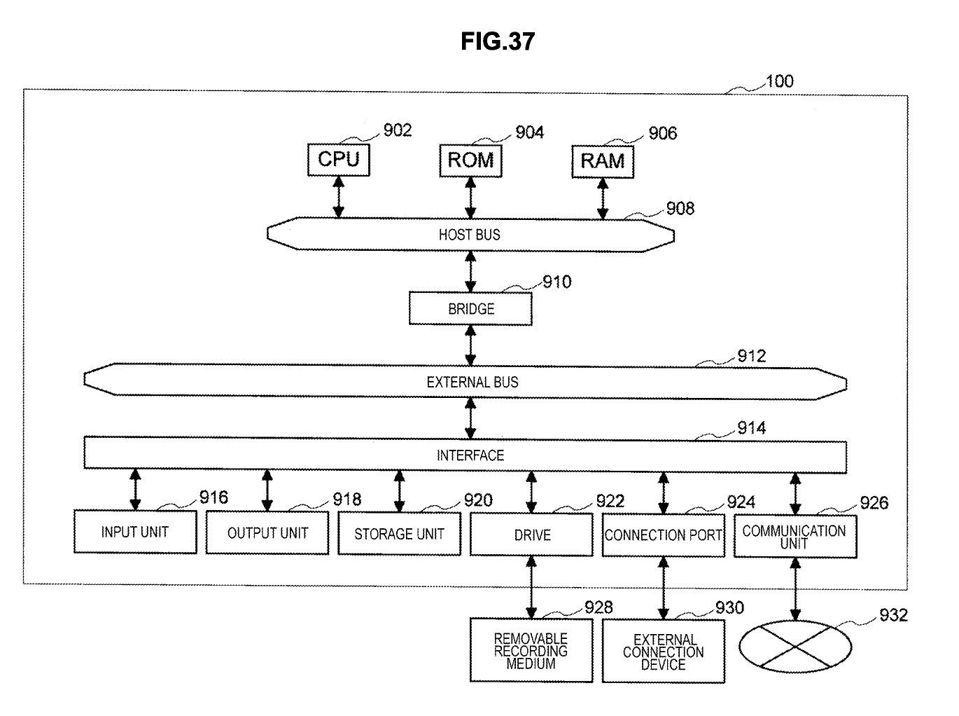

Next, a functional configuration of a reproducing device 100 according to an embodiment will be described with reference to FIG. 12. Next, the flow of a progressive download reproduction process according to an embodiment will be described with reference to FIGS. 13 to 36. Next, a hardware configuration example capable of implementing progressive download reproduction according to the present embodiment will be described with reference to FIG. 37. Lastly, effects obtained from a technical spirit by summarizing the technical spirit of the present embodiment will be briefly described.

### (Description Sections)

1: Beginning
1-1: Configuration of Streaming Distribution System
1-2: Configuration of Reproduction Management File
1-3: Progressive Download Reproduction Using Virtual Package Construction Function
1-4: Progressive Download Reproduction Using Existing Virtual Package

2: Embodiments
2-1: Configuration of Reproducing Device 100
2-2: Flow of Progressive Download Reproduction Process
2-3: Supplement

3: Hardware Configuration Example

4: Summary

### 1: Beginning

First, a configuration of a streaming distribution system capable of executing progressive download reproduction and a general mechanism of progressive download reproduction will be described. Here, a progressive download reproduction mechanism using a virtual package construction function specified in a BD standard and a progressive download reproduction mechanism using an existing virtual package are introduced. A technique according to the present embodiment relates to the progressive download reproduction mechanism using the existing virtual package.

### [1-1: Configuration of Streaming Distribution System]

First, a configuration of a streaming distribution system capable of executing progressive download reproduction will be described with reference to FIG. 1. FIG. 1 is an explanatory diagram for describing a configuration of a streaming distribution system capable of executing progressive download reproduction.

For example, the streaming distribution system is configured with a distribution server 11, a network 12, a reproducing device 100, and a display device 13 as illustrated in FIG. 1. The distribution server 11 distributes content such as audio or a moving image via the network 12. The network 12 is a communication network configured with a wide area network such as the Internet or a local network such as a local area network (LAN). The reproducing device 100 downloads content from the distribution server 11 and reproduces the downloaded content. Here, in the case of progressive download reproduction, the reproducing device 100 sequentially downloads a plurality of stream files configuring content and reproduces the stream files in the downloaded order. The reproduced content is displayed on the display device 13.

In the following, a description will be made in connection with the configuration of the streaming distribution system illustrated in FIG. 1, but the configuration of the streaming distribution system is not limited thereto. For example, when the reproducing device 100 is a BD player, a home video game machine, or the like, the display device 13 and the reproducing device 100 are separate bodies in many cases. Meanwhile, when the reproducing device 100 is a notebook-type personal computer, an information terminal, a portable telephone, a portable video player, a portable music player, a car navigation system, or the like, the reproducing devices 100 include a display device mounted therein in many cases. In this case, the display device 13 is not provided. Instead of the distribution server 11, a configuration may be considered in which content is distributed from an imaging device connected to the network 12. For example, a configuration may be considered in which a live video captured by a video camera or a monitoring camera is distributed to the reproducing device 100 in a streaming manner.

So far, the configuration of the streaming distribution system has been described.

### [1-2: Configuration of Reproduction Management File]

Next, a configuration of a reproduction management file used for reproduction of stream files that conform to the BD standard will be described with reference to FIGS. 2 and 3. FIGS. 2 and 3 are diagrams for describing a configuration of a reproduction management file used for reproduction of stream files that conform to the BD standard. Here, the stream files refer to MPEG2-TS files that conform to the BD standard or MPEG2-TS files including video/audio data that conforms to the BD standard.

The reproduction management file is configured with a play list and clip information files. The play list is configured with a plurality of play items. The play items are associated with the clip information files in a one-to-one manner. The clip information files are associated with the stream files in a one-to-one manner. The play items include references to clip information files, reproduction start times, reproduction finish times, and codec information. Meanwhile, the clip information files include recording rates, numbers of packets, and mapping information for associating time information with positional information. The time information refers to information representing reproduction time. The positional information refers to information representing the position in the stream file.

The information in the play list is represented by a time unit. A user's operation instruction is made in a time unit. For example, an operation instruction such as “skip to a position 15 seconds before the current position,” or “jump to mark attached to a position 5 minutes after the head position” is made. As illustrated in FIG. 2, the clip information file is used to exchange the time information in the play list with the positional information in the stream file. For example, when an operation instruction is given from the user, the reproducing device 100 first refers to the clip information file and then exchanges time information designated by the user with positional information in the stream file as illustrated in FIG. 3. The reproducing device 100 executes reproduction control according to the content of the operation instruction based on the positional information in the stream file obtained by the exchange.

So far, the configuration of the reproduction management file has been described. As described above, the reproduction management file is used for reproduction control of the stream file. For this reason, the reproducing device 100 needs to recognize the reproduction management file in advance in order to reproduce the stream file. The reproduction management file is recognized using, for example, a virtual package construction function.

### [1-3: Progressive Download Reproduction Using Virtual Package Construction Function]

In this regard, a general mechanism of progressive download reproduction using a virtual package construction function will be described with reference to FIGS. 4 to 8. FIGS. 4 to 8 are diagrams for describing a general mechanism of progressive download reproduction using a virtual package construction function.

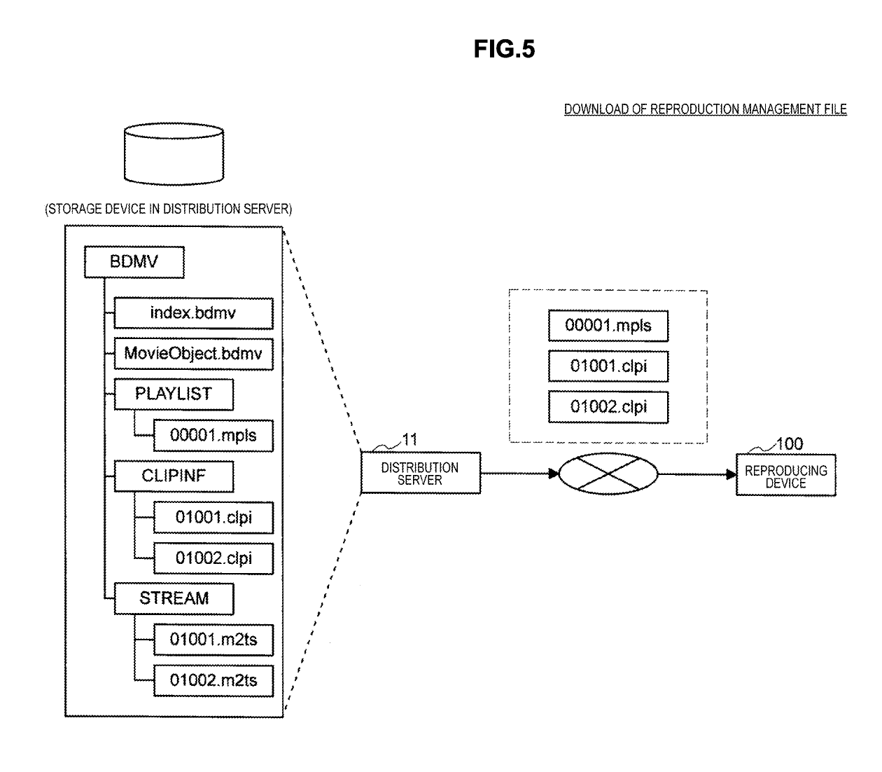

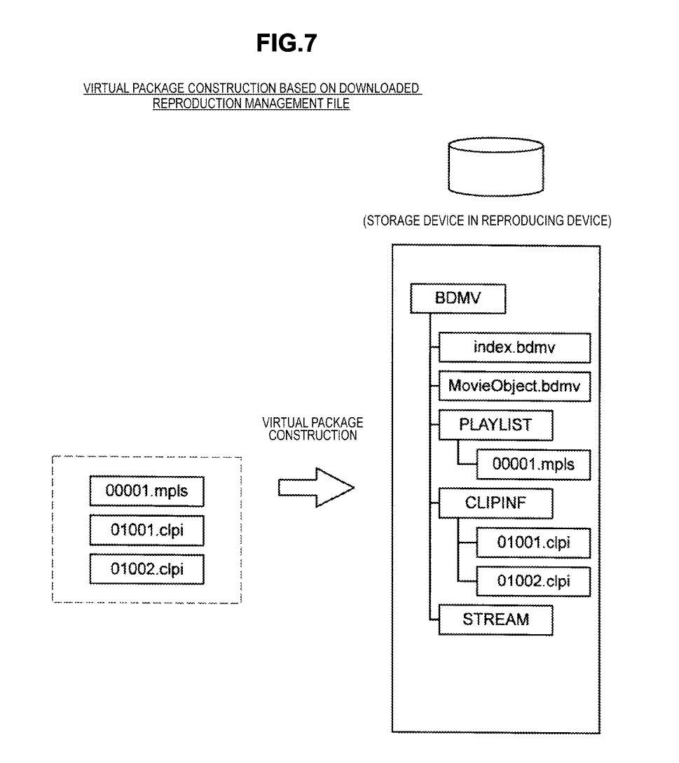

A description will be made below in connection with the flow of a process illustrated in FIG. 4. The reproducing device 100 that has started progressive download reproduction downloads a reproduction management file of content to reproduce from the distribution server 11 as illustrated in FIG. 5 (S11). In the example of FIG. 5, a reproduction management file including a play list “00001.mpls” and clip information files “01001.clpi” and “01002.clpi” is downloaded. Next, the reproducing device 100 constructs a virtual package based on the downloaded reproduction management file as illustrated in FIG. 7 (S12). Here, only mapping with a stream file is defined on a stream file.

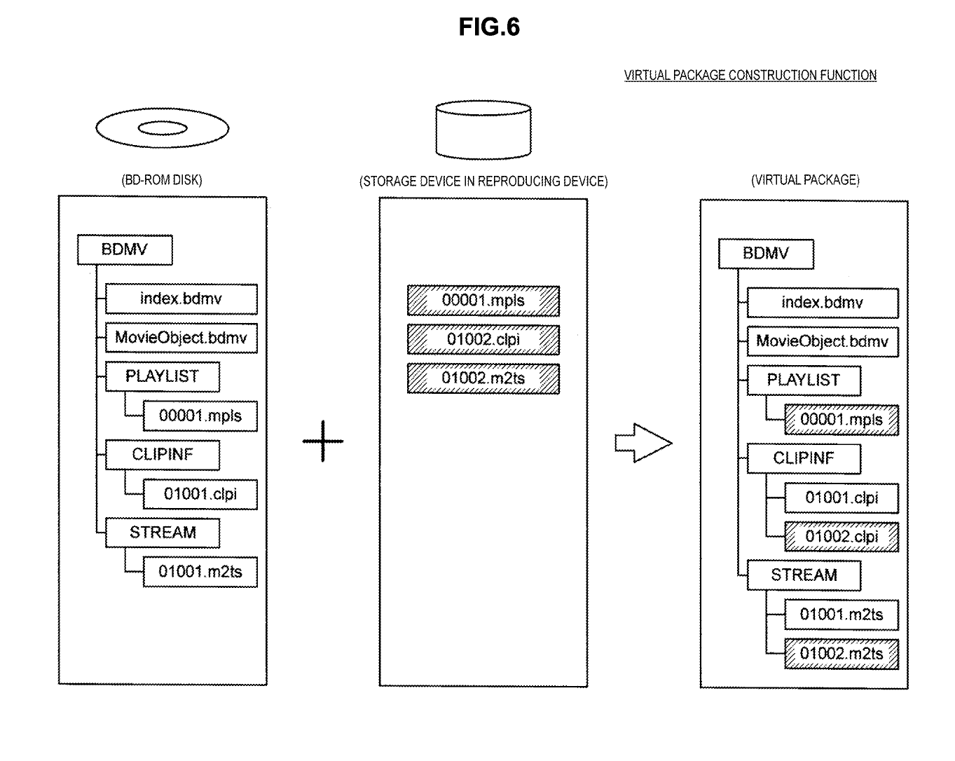

The virtual package construction function refers to a function used when adding downloaded content to content read from a BD-ROM disc as illustrated in FIG. 6. The example of FIG. 6 represents a procedure for adding a stream file “01002.m2ts” to a stream file “01001.m2ts” present in the BD-ROM disc. In order to add the stream file “01002.m2ts,” a play item and a clip information file corresponding to the stream file “01002.m2ts” are necessary. Thus, a new play list “0001.mpls” to which a play item is added and a clip information file “01002.clpi” are given.

As illustrated in FIG. 6, the reproducing device 100 generates a virtual package in which the play list “0001.mpls” is updated with the new play list “0001.mpls,” and the clip information file “01002.clpi” and the stream file “01002.m2ts” are added. Using this function, it is possible to add a subtitle of a new language to content recorded in a BD-ROM or to provide bonus footage. Here, the virtual package constructing process includes a process for recognizing a structure of information included in the reproduction management file such as a correspondence relation among a play item, a clip information file, and a stream file again. For this reason, the virtual package constructing process is high in computation cost. For this reason, when a BD player on the market is used, it takes several seconds to over ten seconds until virtual package construction is completed after it starts.

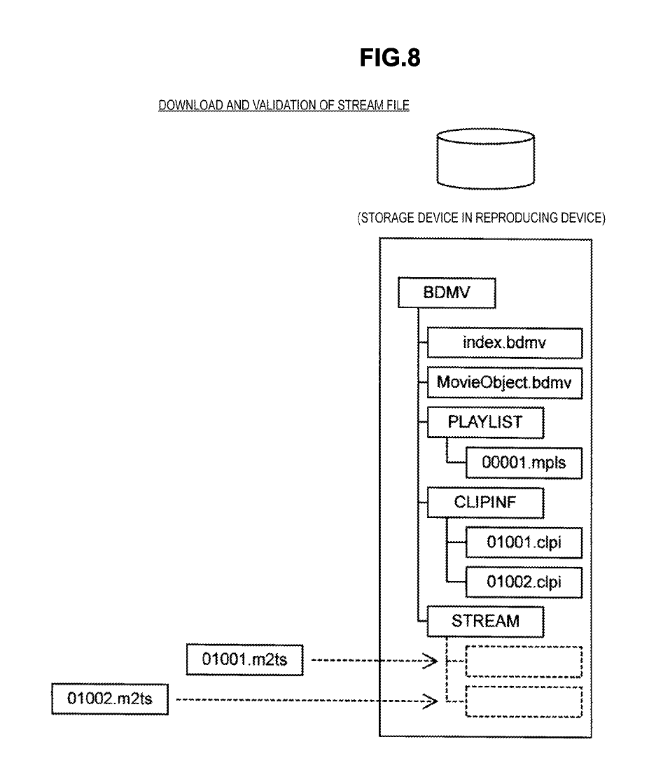

Referring back to FIG. 4, when the virtual package is constructed, the reproducing device 100 downloads the stream file from the distribution server 11 (S13), and then validates the downloaded stream file (S14) as illustrated in FIG. 8. Since mapping with the stream file has been defined in step S12, once the stream file is completely downloaded, the stream file is in a reproducible state. Next, the reproducing device 100 determines whether or not all stream files have been validated (S15). When it is determined that all stream files have been validated, the reproducing device 100 ends a series of processes. However, when it is determined that not all stream files have been validated yet, the reproducing device 100 causes the process to proceed to step S13, and executes the processes of steps S13 to S15 again.

So far, the general mechanism of progressive download reproduction using the virtual package construction function has been described. As described above, using the virtual package construction function, it is possible to implement progressive download reproduction. However, it takes time to construct the virtual package. Further, when the above-described mechanism is used, the virtual package needs to be constructed each time content is switched. For this reason, when the above-described mechanism is used, it is difficult to for the user to comfortably enjoy progressive download reproduction.

### [1-4: Progressive Download Reproduction Using Existing Virtual Package]

In this regard, the inventor(s) has/have invented a mechanism capable of performing progressive download reproduction on various contents without re-constructing the virtual package. An outline of the mechanism will be described with reference to FIGS. 9 to 11.

A description will be made below in connection with the flow of a process illustrated in FIG. 9. The reproducing device 100 that has started progressive download reproduction first acquires an existing virtual package corresponding to a predetermined reproduction management file (S21), and then recognizes the reproduction management file. For example, the reproducing device 100 reads the existing virtual package which has been prepared in advance from a BD-ROM, a storage device, or the like. Further, for example, when the reproducing device 100 is activated, the existing virtual package may be read. Alternatively, for example, when the reproducing device 100 is activated or when first progressive download reproduction is performed, the virtual package may be constructed only once using the downloaded reproduction management file.

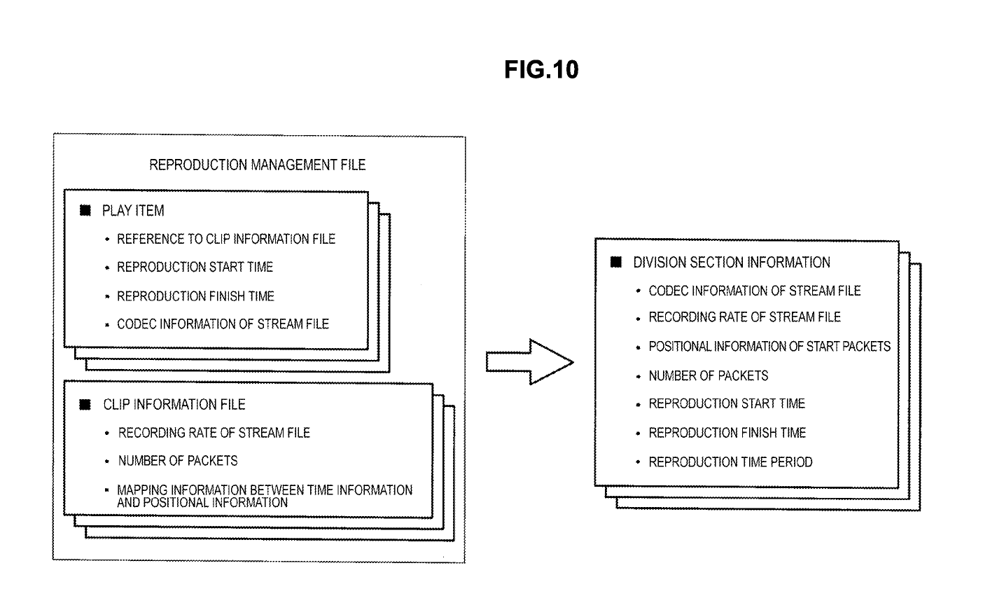

When the existing virtual package is acquired, the reproducing device 100 generates division section information based on the predetermined reproduction management file as illustrated in FIG. 10 (S22). First, the reproducing device 100 extracts a combination of a play item and a clip information file included in a reproduction management file. Next, the reproducing device 100 reads reproduction start time, reproduction finish time, and codec information of a stream file from the play item, and holds the read information as the division section information. Further, the reproducing device 100 reads a recording rate of a stream file, the number of packets, and positional information of a start packet from the clip information file, and holds the read information as the division section information. At this time, the reproducing device 100 acquires the positional information of the start packet based on the mapping information included in the clip information file. Next, the reproducing device 100 calculates a difference (a reproduction time period) between the reproduction finish time and the reproduction start time, and holds the difference as the division section information.

The reproducing device 100 sequentially extracts combinations of the play item and the clip information file included in the reproduction management file, and generates division section information corresponding to each combination. When the division section information is generated, the reproducing device 100 downloads the stream file from the distribution server 11 (S23). Next, the reproducing device 100 divides the stream file based on the division section information generated in step S22, and generates a stream file (S24). The division stream file becomes appropriate for the existing virtual package acquired in step S21.

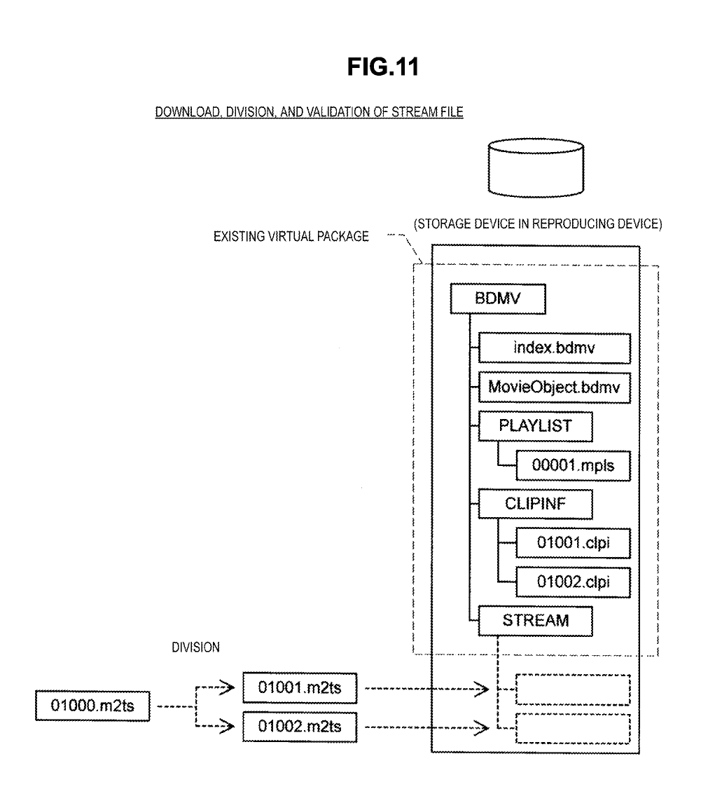

Further, when the number of packets included in the division stream file is different from the number of packets described in the division section information, the reproducing device 100 adds a padding packet (for example, a null packet) to the division stream file to match the content of the division section information. When the division stream file is generated in the above-described way, the reproducing device 100 validates the division stream file as illustrated in FIG. 11 (S25).

Next, the reproducing device 100 determines whether or not the division stream file has been validated on all stream files (S26). When the division stream file has been validated on all stream files, the reproducing device 100 ends a series of processes related to division of the stream file. However, when the division stream file has not been validated on all stream files, the reproducing device 100 causes the process to proceed to step S23, and executes the processes of steps S23 to S25.

So far, the outline of the progressive download reproduction mechanism using the existing virtual package has been described. In the example of FIG. 9, the stream file is divided after the stream file is downloaded, but part of the mechanism may be modified so that the stream file downloading process and the stream file division process can be performed in parallel. That is, the division stream file can be generated using the downloaded packet even in the process of downloading. Through this configuration, an operation for performing switching from a stream file to another stream file can be performed in a state in which the stream file is being downloaded.

For example, when the download speed has decreased, switching to a stream file having a small data amount can be performed in a state in which a stream file is being downloaded. In the progressive download reproduction mechanism which has been known so far, switching of a stream file is performed using a clip information file as a unit, and so switching of a stream file needs to be on standby until a stream file is completely downloaded. However, by applying the above-described mechanism, switching of a stream file can be quickly performed.

As described above, the technique according to the present embodiment relates to the mechanism for dividing the stream file to be compatible with a predetermined reproduction management file. By applying this mechanism, a time necessary for recognizing the reproduction management file can be omitted, and pleasant progressive download reproduction can be implemented. Further, by switching from a stream file to another stream file in the process of downloading, it is possible to quickly adapt to a change in a download speed.

### 2: Embodiments

The outline of the technique according to the present embodiment has been described so far. In the following, the technique according to the present embodiment will be described more specifically or in detail, keeping implementation on the BD player, the home video game machine, or the like in mind.

### [2-1: Configuration of Reproducing Device 100]

First, a functional configuration of the reproducing device 100 according to the present embodiment will be described with reference to FIG. 12. FIG. 12 is an explanatory diagram for describing a functional configuration of the reproducing device 100 according to the present embodiment.

As illustrated in FIG. 12, the reproducing device 100 mainly includes a communication unit 101, a stream file selecting/dividing unit 102, a reproduction control unit 103, and a reproduction management file analyzing unit 104.

The communication unit 101 is a communication means for downloading a file such as a reproduction management file or a stream file from the distribution server 11 via the network 12. Further, the stream file selecting/dividing unit 102 is a means for dividing the stream file and generating the division stream file. Further, the reproduction control unit 103 is a means for executing reproduction control of the division stream file according to the user's operation instruction. Further, the reproduction management file analyzing unit 104 is a means for acquiring the reproduction management file and generating the division section information based on the acquired reproduction management file.

So far, the functional configuration of the reproducing device 100 has been described.

### [2-2: Flow of Progressive Download Reproduction Process]

Next, the flow of the progressive download reproduction process executed by the reproducing device 100 according to the present embodiment will be described with reference to FIGS. 13 to 36. FIGS. 13 to 36 are explanatory diagrams for describing the flow of the progressive download reproduction process executed by the reproducing device 100 according to the present embodiment.

The reproducing device 100 that has started progressive download reproduction selects a stream file which is a download target through the function of the stream file selecting/dividing unit 102, and sets the selected stream file as a stream file of a division target (hereinafter, “input stream”) (S101). Next, the reproducing device 100 sets the number of blank stream files (S102).

Here, the blank stream file will be supplementarily described. The reproducing device 100 such as the BD player executes pre-fetching of a stream file at the time of progressive download reproduction in many cases. For this reason, when a stream file of a pre-fetching target is not valid, the reproducing device 100 outputs an error. For example, when a total reproduction time period obtained by summing reproduction time periods described in all division section information is longer than a reproduction time period of an input stream, the input stream is not reproduced up to the tail end. In this regard, the reproducing device 100 according to the present embodiment generates the division stream file using a packet present at the tail end of the input stream so that the input stream can be reproduced up to the tail end. The division stream file additionally generated in the above-described way is referred to as a blank stream file. The number of blank stream files is set to a number much larger than the number of assumed pre-fetch files.

Then, when the number of blank stream files has been set, the reproducing device 100 sets an MPEG2-TS conversion flag (S103). The MPEG2-TS conversion flag refers to a flag representing whether or not to convert the input stream from the MPEG2-TS format into the M2TS format. For example, when the input stream is converted from the MPEG2-TS format into the M2TS format, the MPEG2-TS conversion flag is set to true. Next, the reproducing device 100 sets a cyclic division flag (S104). The cyclic division flag is a flag representing whether or not to perform cyclic division. For example, when cyclic division is performed, the cyclic division flag is set to true.

The cyclic division refers to a division method used when the reproduction time period of the input stream is longer than a total reproduction time period obtained by summing reproduction time periods of all division section information. The cyclic division is used even when a reproduction time period is not fixed as in a live camera relay.

The cyclic division is implemented by the following process steps. First, the reproducing device 100 causes a division section to transition to the head at a point in time when generation of the division stream file is completed based on last division section information. Next, the reproducing device 100 replaces an input source with a last division stream file and continues a division process. Then, when the last division stream file is read up to the tail end, the reproducing device 100 returns an original input stream file as the input resource again and continues the division process. At the time of reproduction, the reproducing device 100 temporarily stops when a reproduction point in time reaches the last division stream file, and resumes reproduction when the division process has progressed up to the number of pre-fetch files based on first division section information.

Then, the reproducing device 100 that has caused the process to proceed to step S105 acquires a predetermined reproduction management file through the function of the reproduction management file analyzing unit 104, and generates the division section information based on the acquired reproduction management file (S105). Next, the reproducing device 100 sets an input stream switching enable/disable flag to true (S106). Next, the reproducing device 100 sets a video packet detailed process start enable/disable flag to false (S107). Next, the reproducing device 100 starts an input stream division process (S108). At this time, the stream file selecting/dividing unit 102 notifies the reproduction control unit 103 of the start of the division process.

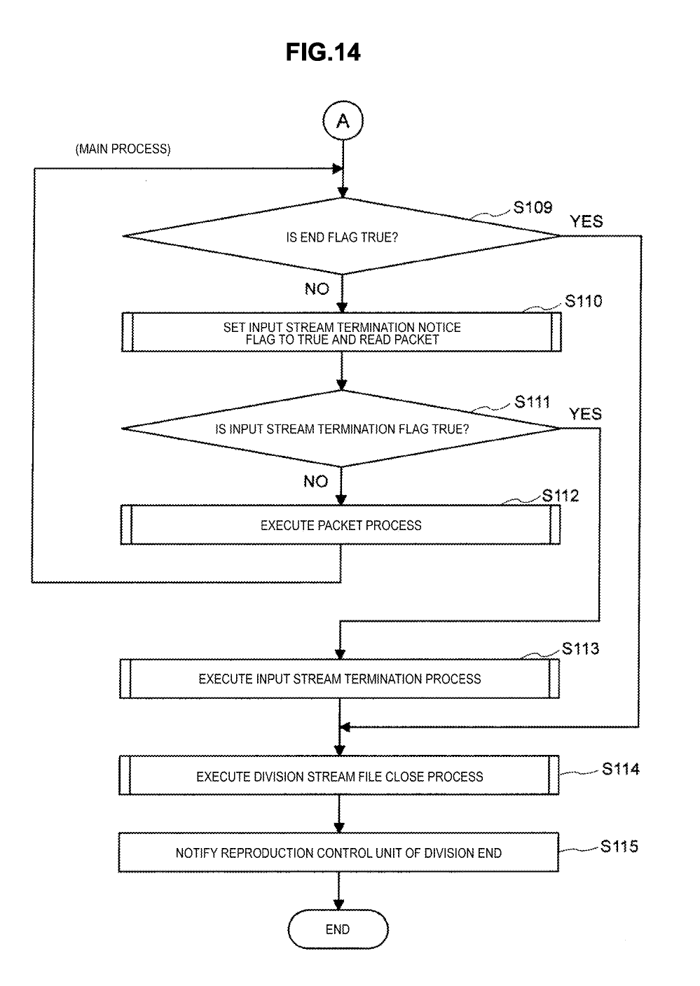

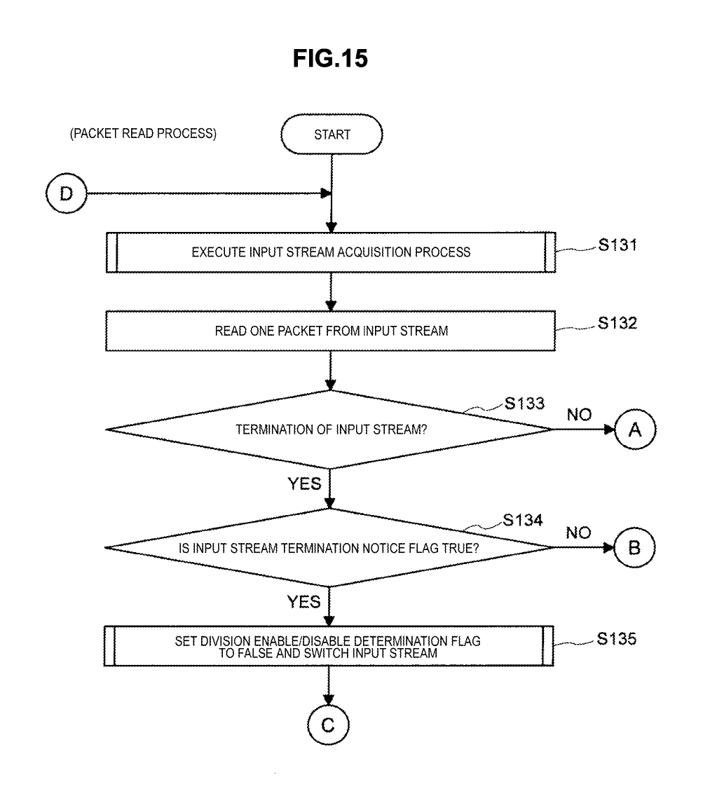

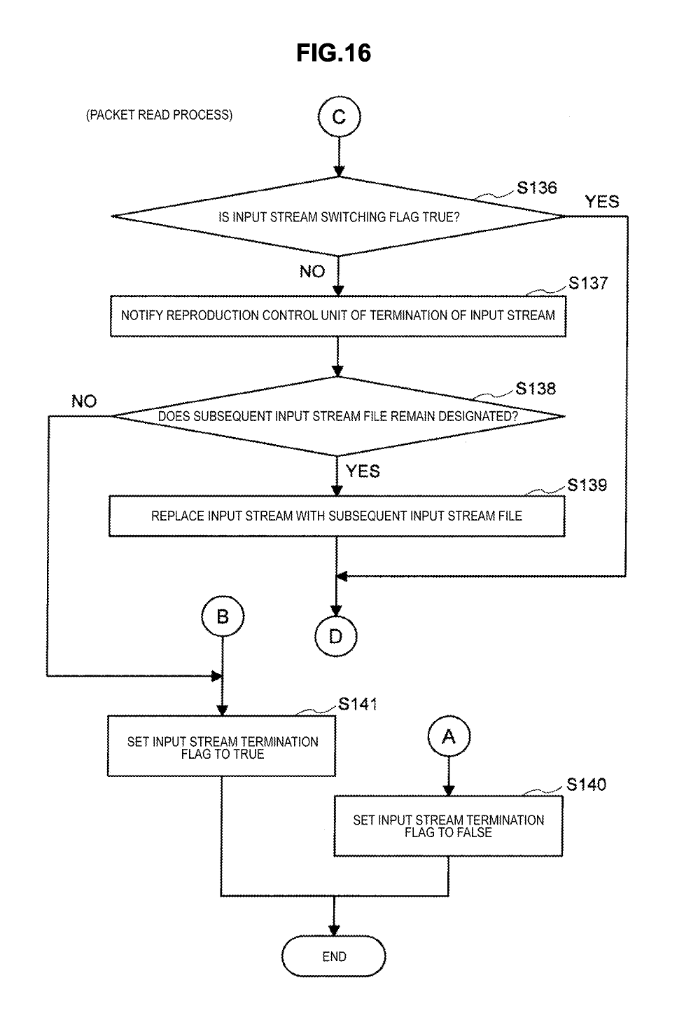

Next, referring to FIG. 14, the reproducing device 100 that has started the division process determines whether or not an end flag remains set to true (S109). Here, an initial value of the end flag is false. When the end flag remains set to true, the reproducing device 100 causes the process to proceed to step S114. However, when the end flag remains set to false, the reproducing device 100 causes the process to proceed to step S110. When the process has proceeded to step S110, the reproducing device 100 sets an input stream termination notice flag to true, and executes a “packet read process (FIGS. 15 and 16)” (S110). The details of the “packet read process (FIGS. 15 and 16)” will be described later.

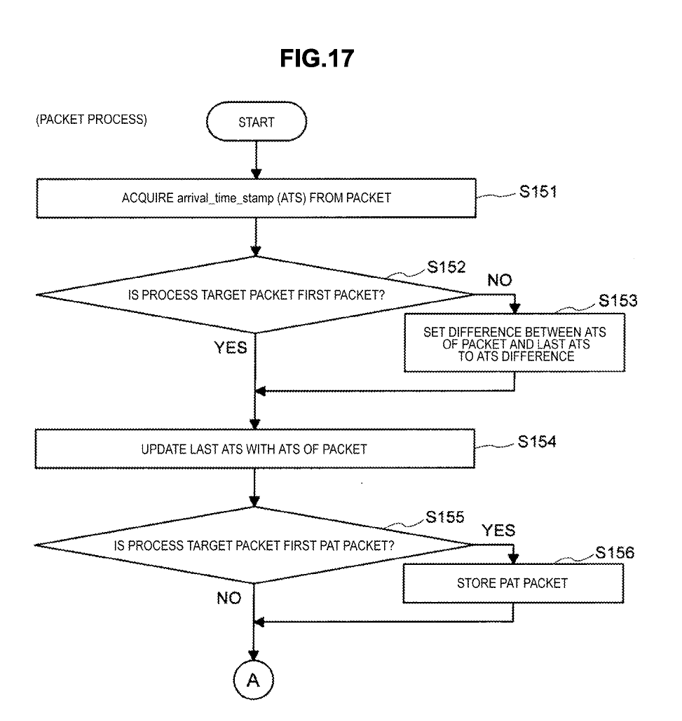

Next, the reproducing device 100 determines whether or not an input stream termination flag remains set to true (S111). When the input stream termination flag remains set to true, the reproducing device 100 causes the process to proceed to step S113. However, when the input stream termination flag remains set to false, the reproducing device 100 causes the process to proceed to step S112. When the process has proceeded to step S112, the reproducing device 100 executes a “packet process (FIGS. 17 to 19)” (S112), and then causes the process to proceed to step S109. The details of the “packet process (FIGS. 17 to 19)” will be described later.

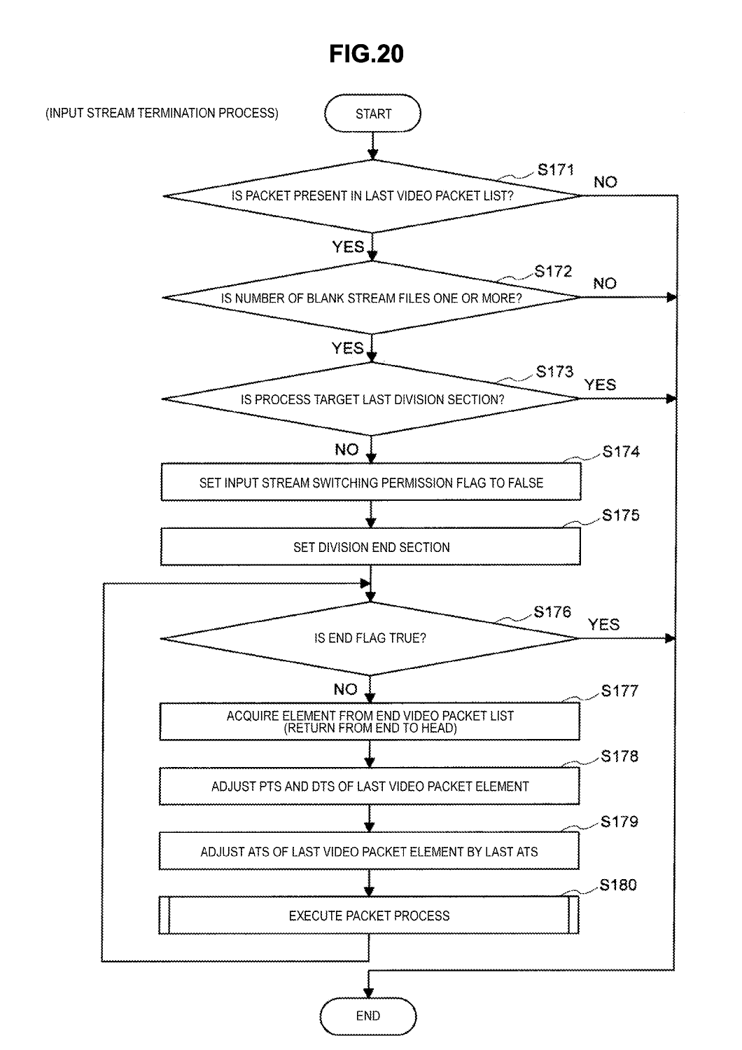

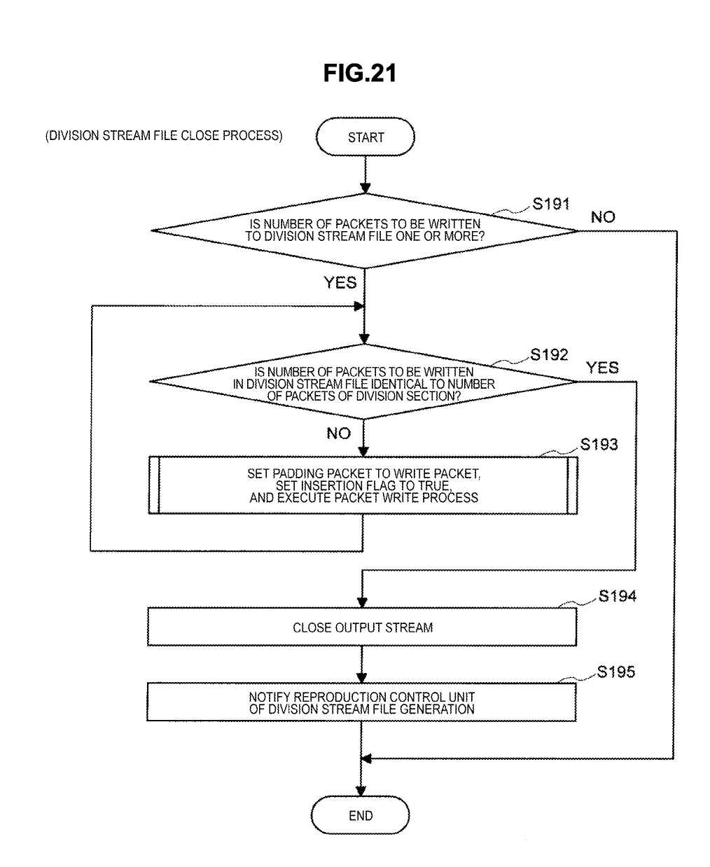

When the process has proceeded to step S113, the reproducing device 100 executes an “input stream termination process (FIG. 20)” (S113). The details of the “input stream termination process (FIG. 20)” will be described later. Next, the reproducing device 100 executes a “division stream file close process (FIG. 21)” (S114). The details of the “division stream file close process (FIG. 21)” will be described later.

Next, the reproducing device 100 ends the input stream division process (S115), and ends a series of processes related to progressive download reproduction. At this time, the stream file selecting/dividing unit 102 notifies the reproduction control unit 103 of the end of the division process.

So far, the general flow of the progressive download reproduction process executed by the reproducing device 100 according to the present embodiment has been described. Next, the “packet read process (FIGS. 15 and 16),” the “packet process (FIGS. 17 to 19),” the “input stream termination process (FIG. 20),” and the “division stream file close process (FIG. 21)” will be described in detail.

### (Details of “Packet Read Process (FIGS. 15 and 16)”)

First, the details of the “packet read process (FIGS. 15 and 16)” will be described with reference to FIGS. 15 and 16. FIGS. 15 and 16 are explanatory diagrams for describing the details of the “packet read process (FIGS. 15 and 16).”

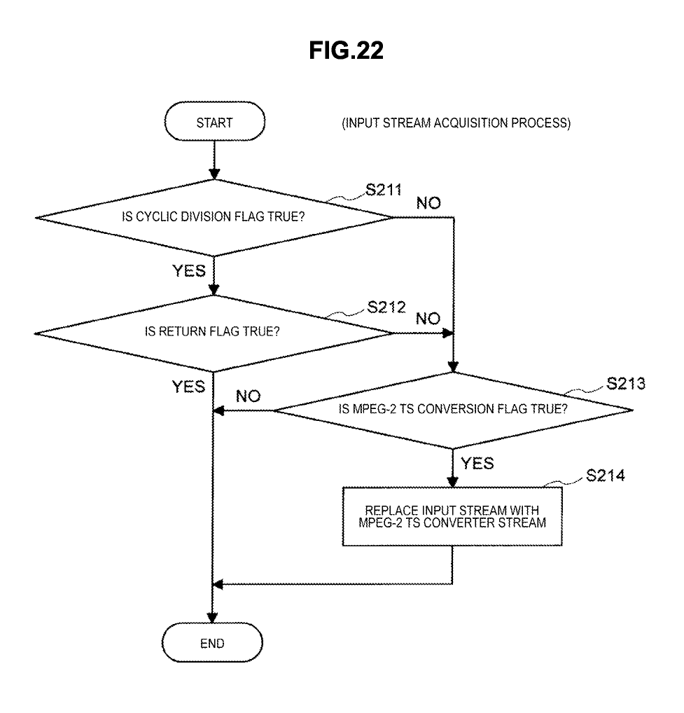

As illustrated in FIG. 15, the reproducing device 100 that has started the packet read process executes the “input stream acquisition process (FIG. 22)” (S131). The details of the “input stream acquisition process (FIG. 22)” will be described later. Next, the reproducing device 100 reads one packet from the input stream acquired in step S131 (S132). Next, the reproducing device 100 determines whether or not the packet read in step S132 is positioned at the termination point of the input stream (S133). When the read packet is positioned at the termination point of the input stream, the reproducing device 100 causes the process to proceed to step S134. However, when the read packet is not positioned at the termination point of the input stream, the reproducing device 100 causes the process to proceed to step S140 (FIG. 16).

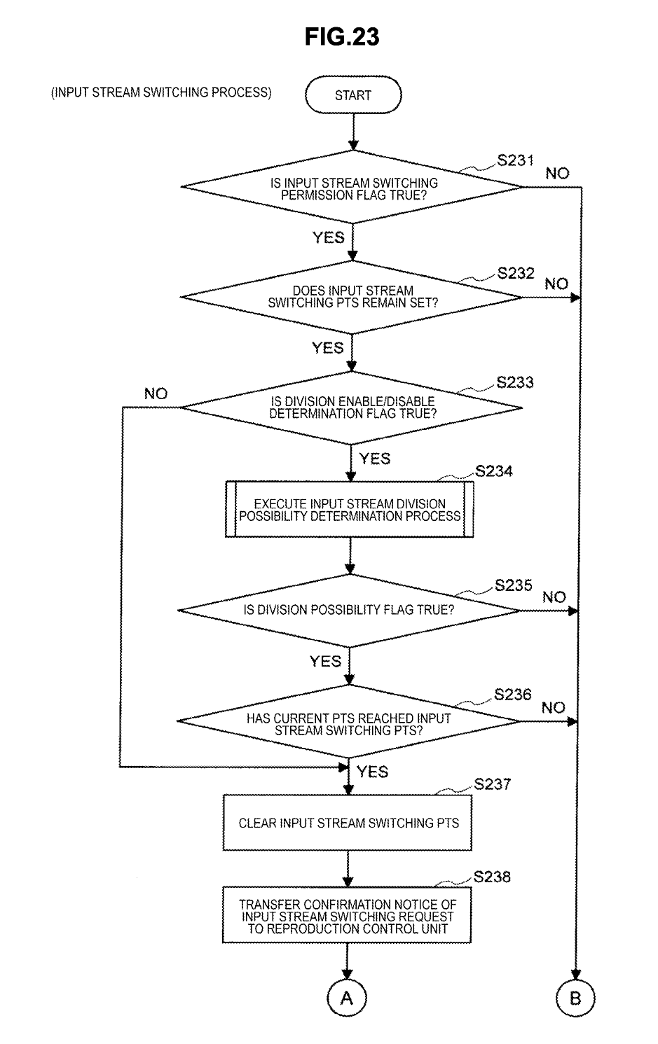

When the process has proceeded to step S134, the reproducing device 100 determines whether or not the input stream termination notice flag remains set to true (S134). When the input stream termination notice flag remains set to true, the reproducing device 100 causes the process to proceed to step S135. However, when the input stream termination notice flag remains set to false, the reproducing device 100 causes the process to proceed to step S141 (FIG. 16). When the process has proceeded to step S135, the reproducing device 100 sets a division enable/disable determination flag to false, and executes an “input stream switching process (FIGS. 23 to 25)” (S135). The details of the “input stream switching process (FIGS. 23 to 25)” will be described later.

Next, referring to FIG. 16, after the “input stream switching process (FIGS. 23 to 25)” is executed, the reproducing device 100 causes the process to proceed to step S136, and determines whether or not the input stream switching flag remains set to true (S136). When the input stream switching flag remains set to true, the reproducing device 100 causes the process to proceed to step S131 (FIG. 15). However, when the input stream switching flag remains set to false, the reproducing device 100 causes the process to proceed to step S137.

When the process has proceeded to step S137, the reproducing device 100 specifies a packet present at the termination point of the input stream (S137). At this time, the stream file selecting/dividing unit 102 notifies the reproduction control unit 103 of the termination position of the input stream. Next, the reproducing device 100 determines whether or not a stream file (hereinafter, “subsequent input stream file”) input subsequent to a current input stream remains designated (S138). When the subsequent input stream file remains designated, the reproducing device 100 causes the process to proceed to step S139. However, when the subsequent input stream file does not remain designated, the reproducing device 100 causes the process to proceed to step S141.

When the process has proceeded to step S139, the reproducing device 100 replaces the input stream with the subsequent input stream file (S139), and then causes the process to proceed to step S131. When the process has proceeded to step S140, the reproducing device 100 sets the input stream termination flag to false (S140), and ends a series of processes related to the “packet read process (FIGS. 15 and 16).” When the process has proceeded to step S141, the reproducing device 100 sets the input stream termination flag to true (S141), and ends a series of processes related to the “packet read process (FIGS. 15 and 16).”

So far, the details of the “packet read process (FIGS. 15 and 16)” have been described.

### (Details of “Packet Process (FIGS. 17 to 19)”)

Next, the details of the “packet process (FIGS. 17 to 19)” will be described with reference to FIGS. 17 to 19. FIGS. 17 to 19 are explanatory diagrams for describing the details of the “packet process (FIGS. 17 to 19).”

As illustrated in FIG. 17, the reproducing device 100 that has started the packet process acquires arrival_time_stamp (hereinafter, “ATS”) from a process target packet (S151). Next, the reproducing device 100 determines whether or not a process target packet is a first packet (S152). When the process target packet is the first packet, the reproducing device 100 causes the process to proceed to step S154. However, when the process target packet is not the first packet, the reproducing device 100 causes the process to proceed to step S153. When the process has proceeded to step S153, the reproducing device 100 sets a difference between the ATS of the packet and the last ATS as an ATS difference (S153), and then causes the process to proceed to step S154.

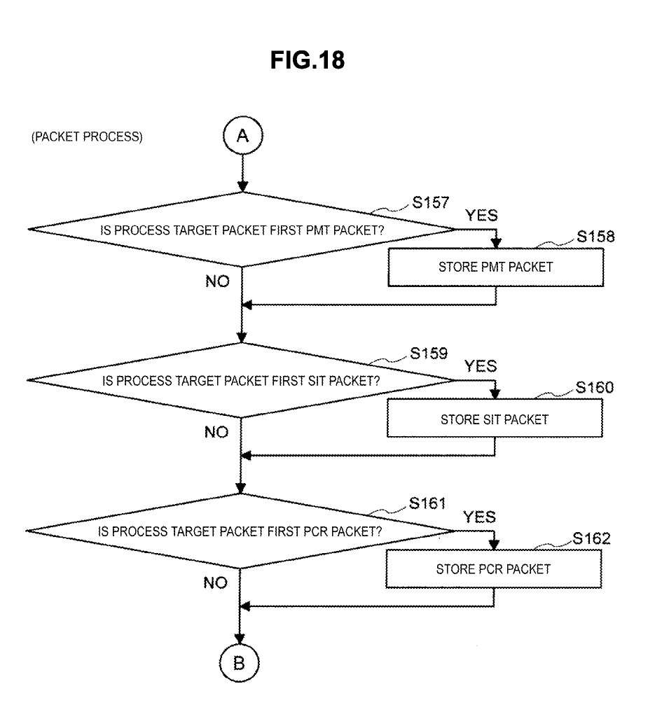

When the process has proceeded to step S154, the reproducing device 100 updates the last ATS with the ATS of the process target packet (S154). Next, the reproducing device 100 determines whether or not the process target packet is a first PAT packet (S155). When the process target packet is the first PAT packet, the reproducing device 100 causes the process to proceed to step S156. However, when the process target packet is not the first PAT packet, the reproducing device 100 causes the process to proceed to step S157 (FIG. 18). When the process has proceeded to step S156, the reproducing device 100 stores the PAT packet (the process target packet) (S156), and then causes the process to proceed to step S157 (FIG. 18).

Next, referring to FIG. 18, the reproducing device 100 that has caused the process to step S157 determines whether or not the process target packet is a first PMT packet (S157). When the process target packet is the first PMT packet, the reproducing device 100 causes the process to proceed to step S158. However, when the process target packet is not the first PMT packet, the reproducing device 100 causes the process to proceed to step S159. When the process has proceeded to step S158, the reproducing device 100 stores the PMT packet (the process target packet) (S158), and then causes the process to proceed to step S159.

The reproducing device 100 that has caused the process to proceed to step S159 determines whether or not the process target packet is a first SIT packet (S159). When the process target packet is the first SIT packet, the reproducing device 100 causes the process to proceed to step S161. However, when the process target packet is not the first SIT packet, the reproducing device 100 causes the process to proceed to step S160. When the process has proceeded to step S160, the reproducing device 100 stores the SIT packet (the process target packet) (S160), and then causes the process to proceed to step S161.

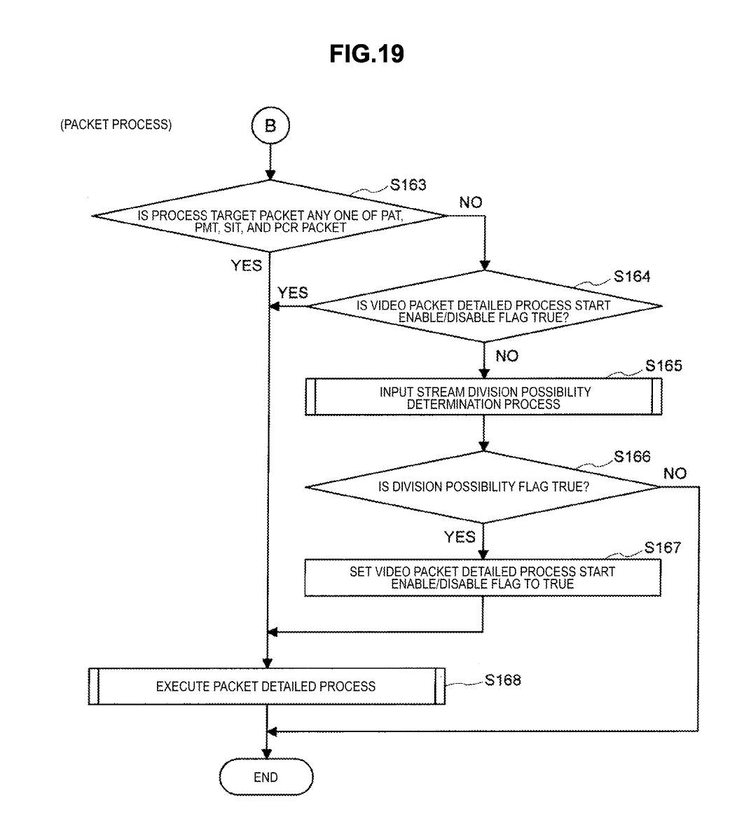

The reproducing device 100 that has caused the process to proceed to step S161 determines whether or not the process target packet is a first PCR packet (S161). When the process target packet is the first PCR packet, the reproducing device 100 causes the process to proceed to step S163. However, when the process target packet is not the first PCR packet, the reproducing device 100 causes the process to proceed to step S162. When the process has proceeded to step S162, the reproducing device 100 stores the PCR packet (the process target packet) (S162), and then causes the process to proceed to step S163 (FIG. 19).

Next, referring to FIG. 19, the reproducing device 100 that has caused the process to proceed to step S163 determines whether or not the process target packet is any one of the PAT packet, the PMT packet, the SIT packet, and the PCR packet (S163). When the process target packet is any one of the PAT packet, the PMT packet, the SIT packet, and the PCR packet, the reproducing device 100 causes the process to proceed to step S168. However, when the process target packet is not any of the PAT packet, the PMT packet, the SIT packet, and the PCR packet, the reproducing device 100 causes the process to proceed to step S164.

When the process has proceeded to step S164, the reproducing device 100 determines whether the video packet detailed process start enable/disable flag remains set to true (S164). When the video packet detailed process start enable/disable flag remains set to true, the reproducing device 100 causes the process to proceed to step S168. However, when the video packet detailed process start enable/disable flag remains set to false, the reproducing device 100 causes the process to proceed to step S165.

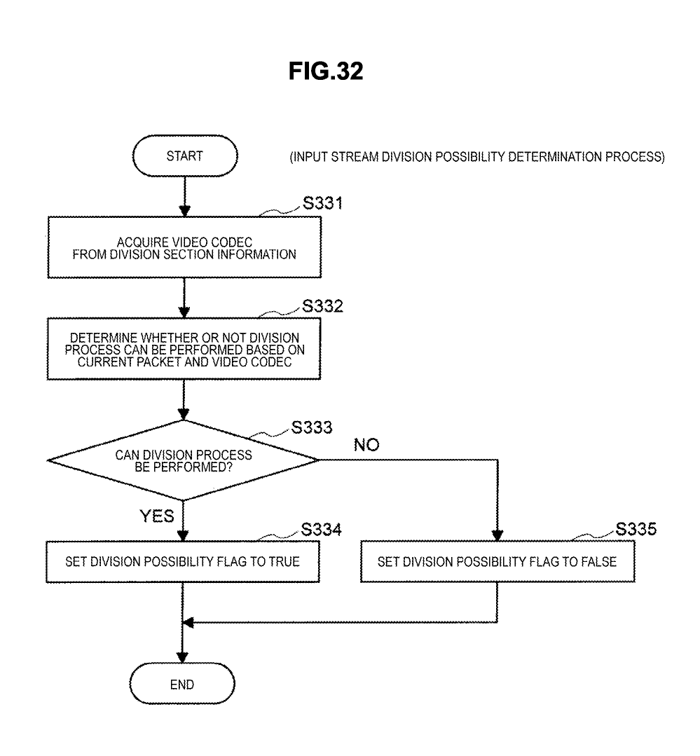

When the process has proceeded to step S165, the reproducing device 100 executes an “input stream division possibility determination process (FIG. 32)” (S165). Next, the reproducing device 100 determines whether or not the division possibility flag remains set to true (S166). When the division possibility flag remains set to true, the reproducing device 100 causes the process to proceed to step S167. However, when the division possibility flag remains set to false, the reproducing device 100 ends a series of processes related to the “packet process (FIGS. 17 to 19).”

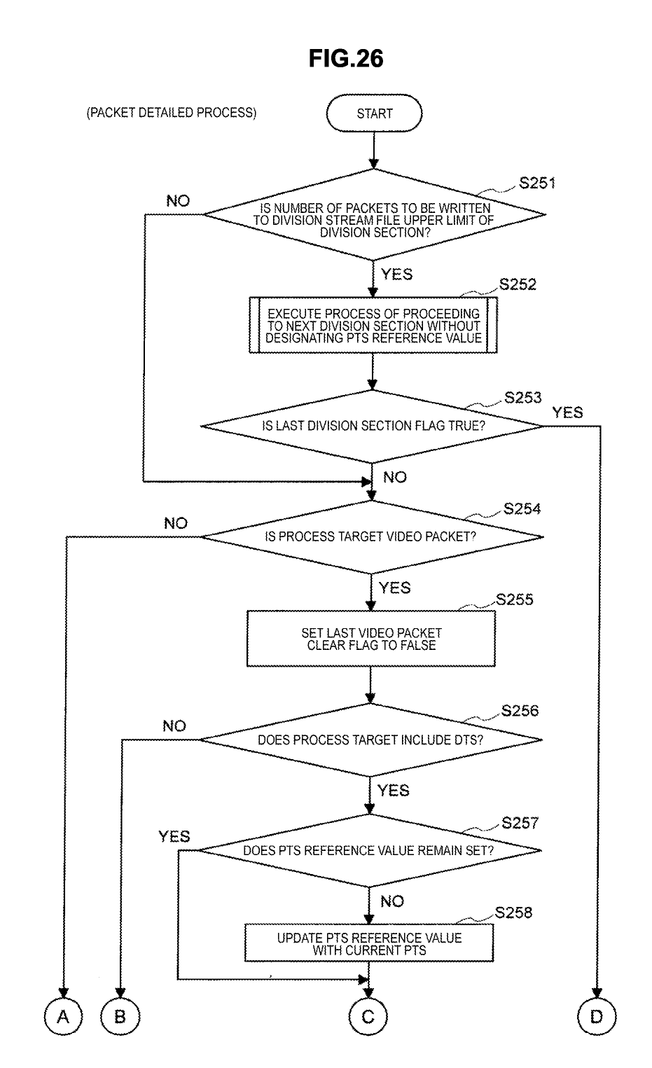

When the process has proceeded to step S167, the reproducing device 100 sets the video packet detailed process start enable/disable flag to true (S167), and then causes the process to proceed to step S168. The reproducing device 100 that has caused the process to proceed to step S168 executes the “packet detailed process (FIGS. 26 to 28)” (S168), and then ends a series of processes related to the “packet process (FIGS. 17 to 19).” The details of the “packet detailed process (FIGS. 26 to 28)” will be described later.

So far, the details of the “packet process (FIGS. 17 to 19)” have been described.

### (Details of “Input Stream Termination Process (FIG. 20)”)

Next, the details of the “input stream termination process (FIG. 20)” will be described with reference to FIG. 20. FIG. 20 is an explanatory diagram for describing the details of the “input stream termination process (FIG. 20).”

As illustrated in FIG. 20, the reproducing device 100 that has started the input stream termination process determines whether or not a packet is present in the last video packet list (S171). When a packet is present in the last video packet list, the reproducing device 100 causes the process to proceed to step S172. However, when no packet is present in the last video packet list, the reproducing device 100 ends a series of processes related to the “input stream termination process (FIG. 20).”

When the process has proceeded to step S172, the reproducing device 100 determines whether or not the number of blank stream files is one or more (S172). When the number of blank stream files is one or more, the reproducing device 100 causes the process to proceed to step S173. However, when the number of blank stream files is zero (0), the reproducing device 100 ends a series of processes related to the “input stream termination process (FIG. 20).”

When the process has proceeded to step S173, the reproducing device 100 determines whether or not the process target is the last division section (S173). When the process target is the last division section, the reproducing device 100 ends a series of processes related to the “input stream termination process (FIG. 20).” However, when the process target is not the last division section, the reproducing device 100 causes the process to proceed to step S174.

When the process has proceeded to step S174, the reproducing device 100 sets the input stream switching permission flag to false (S174). Next, the reproducing device 100 sets a division end section (S175). The division end section refers to a division section corresponding to the tail end of a blank stream file added when the reproduction time period of the input stream is shorter than the total reproduction time period obtained by summing reproduction time periods of all division section information.

Next, the reproducing device 100 determines whether or not the end flag remains set to true (S176). When the end flag remains set to true, the reproducing device 100 ends a series of processes related to the “input stream termination process (FIG. 20).” However, when the end flag remains set to false, the reproducing device 100 causes the process to proceed to step S177. When the process has proceeded to step S177, the reproducing device 100 acquires an element (a last video packet element) from the end video packet list (S177). However, when it has reached the tail end, it returns to the head.

Next, the reproducing device 100 adjusts a PTS and a DTS of the last video packet element (S178). Next, the reproducing device 100 adjusts the ATS of the last video packet element based on the last ATS (S179). Next, the reproducing device 100 executes the “packet process (FIGS. 17 to 19)” (S180), and then causes the process to proceed to step S176.

So far, the details of the “input stream termination process (FIG. 20)” have been described.

### (Details of “Division Stream File Close Process (FIG. 21)”)

Next, the details of the “division stream file close process (FIG. 21)” will be described with reference to FIG. 21. FIG. 21 is an explanatory diagram for describing the details of the “division stream file close process (FIG. 21).”

As illustrated in FIG. 21, the reproducing device 100 that has started the division stream file close process determines whether or not the number of packets to be written in the division stream file is one or more (S191). When the number of packets to be written in the division stream file is zero (0), the reproducing device 100 ends a series of processes related to the “division stream file close process (FIG. 21).” However, when the number of packets to be written in the division stream file is one or more, the reproducing device 100 causes the process to proceed to step S192.

When the process has proceeded to step S192, the reproducing device 100 determines whether or not the number of packets to be written in the division stream file is identical to the number of packets of the division section (S192). When the number of packets to be written in the division stream file is identical to the number of packets of the division section, the reproducing device 100 causes the process to proceed to step S194. However, when the number of packets to be written in the division stream file is not identical to the number of packets of the division section, the reproducing device 100 causes the process to proceed to step S193.

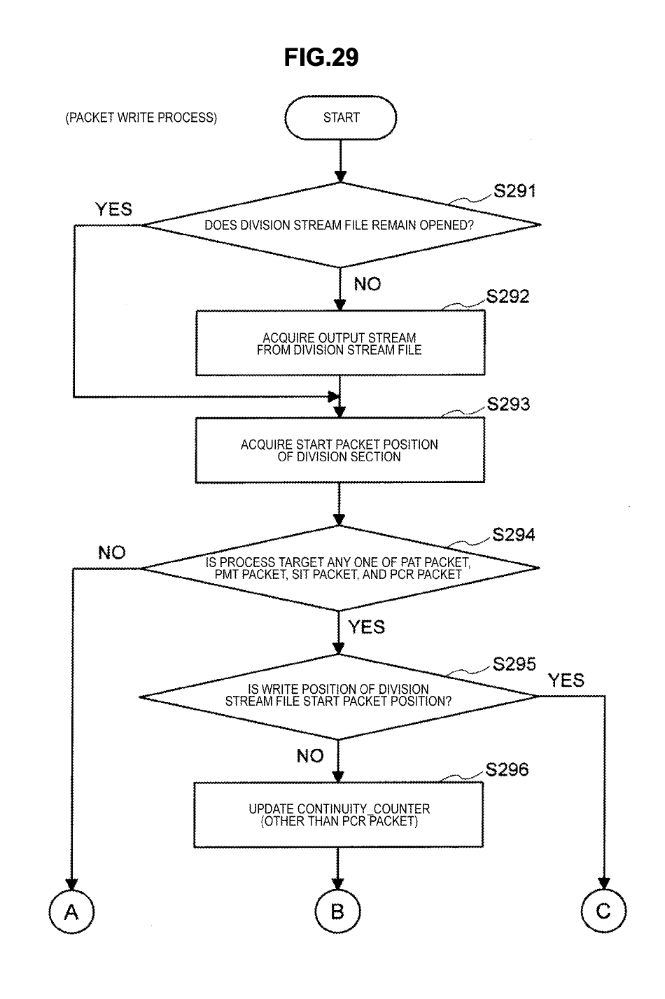

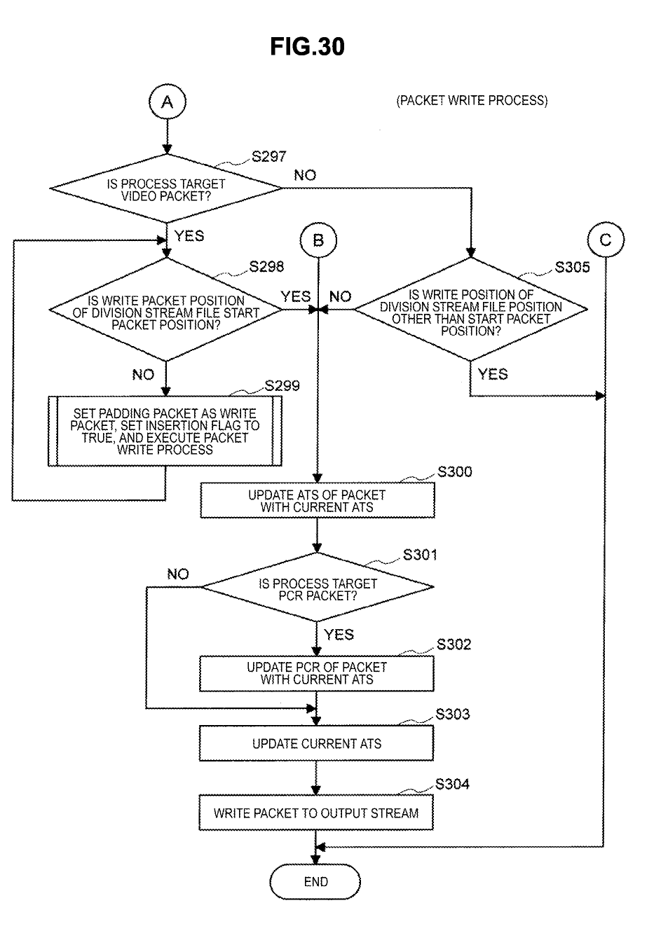

When the process has proceeded to step S193, the reproducing device 100 sets a padding packet as a packet to be written, sets the insertion flag to true, and executes the “packet write process (FIGS. 29 and 30)” (S193). After the process of step S193 is executed, the reproducing device 100 causes the process to proceed to step S192.

When the process has proceeded to step S194, the reproducing device 100 closes an output stream (division stream file) (S194). Thereafter, the stream file selecting/dividing unit 102 notifies the reproduction control unit 103 of generation completion of the division stream file (S195), and ends a series of processes related to the “division stream file close process (FIG. 21).”

So far, the details of the “division stream file close process (FIG. 21)” have been described.

Next, the “input stream acquisition process (FIG. 22),” the “input stream switching process (FIGS. 23 to 25),” the “packet detailed process (FIGS. 26 to 28),” and the “packet write process (FIGS. 29 and 30),” which have been mentioned above, will be described in detail.

### (Details of “Input Stream Acquisition Process (FIG. 22)”)

First, the details of the “input stream acquisition process (FIG. 22)” will be described with reference to FIG. 22. FIG. 22 is an explanatory diagram for describing the details of the “input stream acquisition process (FIG. 22).”

As illustrated in FIG. 22, the reproducing device 100 that has started the input stream acquisition process determines whether or not the cyclic division flag remains set to true (S211). When the cyclic division flag remains set to true, the reproducing device 100 causes the process to proceed to step S212. However, when the cyclic division flag remains set to false, the reproducing device 100 causes the process to proceed to step S213.

When the process has proceeded to step S212, the reproducing device 100 determines whether or not a return flag remains set to true (S212). When the return flag remains set to true, the reproducing device 100 ends a series of processes related to the “input stream acquisition process (FIG. 22).” However, when the return flag remains set to false, the reproducing device 100 causes the process to proceed to step S213.

When the process has proceeded to step S213, the reproducing device 100 determines whether or not the MPEG2-TS conversion flag remains set to true (S213). When the MPEG2-TS conversion flag remains set to true, the reproducing device 100 causes the process to proceed to step S214. However, when the MPEG2-TS conversion flag remains set to false, the reproducing device 100 ends a series of processes related to the “input stream acquisition process (FIG. 22).” When the process has proceeded to step S214, the reproducing device 100 replaces the input stream with an MPEG2-TS converter stream (S214), and then ends a series of processes related to the “input stream acquisition process (FIG. 22).”

So far, the details of the “input stream acquisition process (FIG. 22)” have been described.

### (Details of “Input Stream Switching Process (FIGS. 23 to 25)”)

Next, the details of the “input stream switching process (FIGS. 23 to 25)” will be described with reference to FIGS. 23 to 25. FIGS. 23 to 25 are explanatory diagrams for describing the details of the “input stream switching process (FIGS. 23 to 25).”

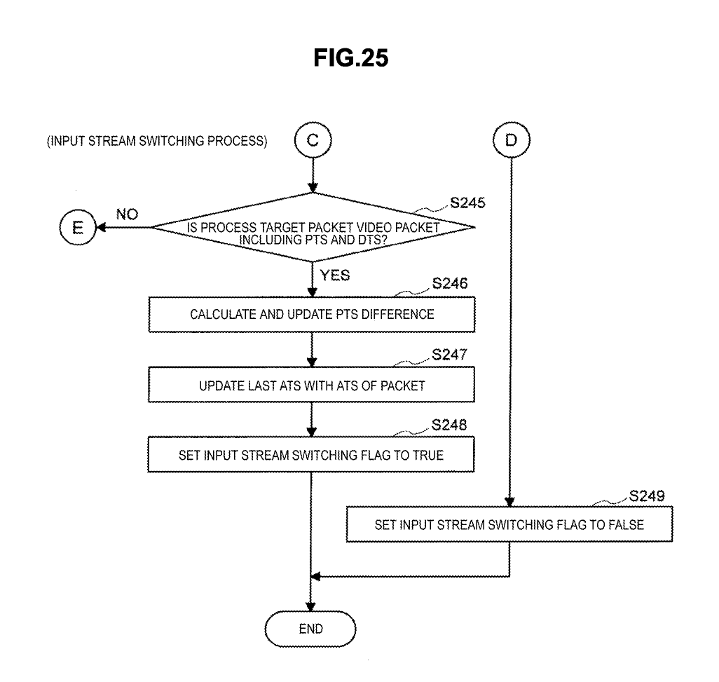

As illustrated in FIG. 23, the reproducing device 100 that has started the input stream switching process determines whether or not the input stream switching permission flag remains set to true (S231). When the input stream switching permission flag remains set to true, the reproducing device 100 causes the process to proceed to step S232. However, when the input stream switching permission flag remains set to false, the reproducing device 100 causes the process to proceed to step S249 (FIG. 25).

When the process has proceeded to step S232, the reproducing device 100 determines whether or not the input stream switching PTS remains set (S232). When the input stream switching PTS remains set, the reproducing device 100 causes the process to proceed to step S233. However, when the input stream switching PTS does not remain set, the reproducing device 100 causes the process to proceed to step S249 (FIG. 25).

When the process has proceeded to step S233, the reproducing device 100 determines whether or not the division enable/disable determination flag remains set to true (S233). When the division enable/disable determination flag remains set to true, the reproducing device 100 causes the process to proceed to step S234. However, when the division enable/disable determination flag remains set to false, the reproducing device 100 causes the process to proceed to step S237. When the process has proceeded to step S234, the reproducing device 100 executes the “input stream division possibility determination process (FIG. 32)” (S234).

Next, the reproducing device 100 determines whether or not the division possibility flag remains set to true (S235). When the division possibility flag remains set to true, the reproducing device 100 causes the process to proceed to step S236. However, when the division possibility flag remains set to false, the reproducing device 100 causes the process to proceed to step S249 (FIG. 25).

When the process has proceeded to step S236, the reproducing device 100 determines whether or not a current PTS has reached the input stream switching PTS (S236). When the current PTS has reached the input stream switching PTS, the reproducing device 100 causes the process to proceed to step S237. However, when the current PTS has not reached the input stream switching PTS, the reproducing device 100 causes the process to proceed to step S249 (FIG. 25).

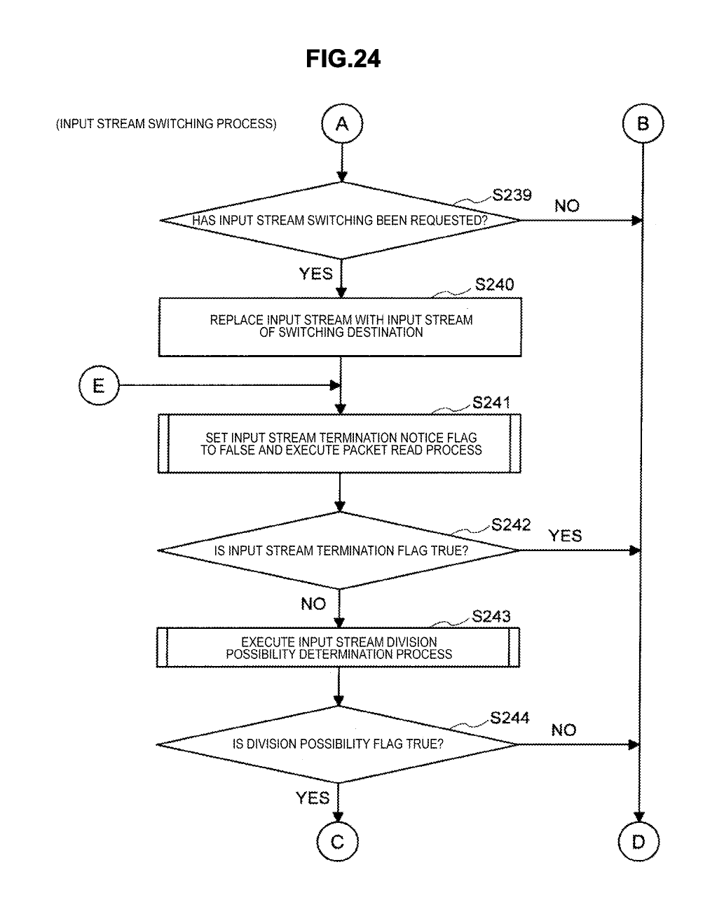

When the process has proceeded to step S237, the reproducing device 100 clears the input stream switching PTS (S237). Thereafter, the stream file selecting/dividing unit 102 transfers a confirmation notice of an input stream switching request to the reproduction control unit 103 (S238), and causes the process to proceed to step S239(FIG. 24).

Next, referring to FIG. 24, the reproducing device 100 that has caused the process to proceed to step S239 determines whether or not input stream switching has been requested (S239). When the input stream switching has been requested, the reproducing device 100 causes the process to proceed to step S240. However, when the input stream switching has not been requested, the reproducing device 100 causes the process to proceed to step S249 (FIG. 25).

When the process has proceeded to step S240, the reproducing device 100 replaces the input stream with an input stream of a switching destination (S240). Next, the reproducing device 100 sets the input stream termination notice flag to false, and executes the “packet read process (FIGS. 15 and 16)” (S241).

Next, the reproducing device 100 determines whether or not the input stream termination flag remains set to true (S242). When the input stream termination flag remains set to true, the reproducing device 100 causes the process to proceed to step S249 (FIG. 25). However, when the input stream termination flag remains set to false, the reproducing device 100 causes the process to proceed to step S243.

When the process has proceeded to step S243, the reproducing device 100 executes the “input stream division possibility determination process (FIG. 32)” (S243). The details of the “input stream division possibility determination process (FIG. 32)” will be described later.

Next, the reproducing device 100 determines whether or not the division possibility flag remains set to true (S244). When the division possibility flag remains set to true, the reproducing device 100 causes the process to proceed to step S245 (FIG. 25). However, when the division possibility flag remains set to false, the reproducing device 100 causes the process to proceed to step S249 (FIG. 25).

Next, referring to FIG. 25, when the process has proceeded to step S245, the reproducing device 100 determines whether or not the process target is a video packet including the PTS and DTS (S245). When the process target is the video packet including the PTS and DTS, the reproducing device 100 causes the process to proceed to step S246. However, when the process target is not the video packet including the PTS and DTS, the reproducing device 100 causes the process to proceed to step S241 (FIG. 24).

When the process has proceeded to step S246, the reproducing device 100 calculates the PTS difference, and updates the PTS difference with the calculated value (S246). Next, the reproducing device 100 updates the last ATS with the ATS of the packet (S247). Next, the reproducing device 100 sets the input stream switching flag to true (S248), and then ends a series of processes related to the “input stream switching process (FIGS. 23 to 25).” Further, when the process has proceeded to step S249, the reproducing device 100 sets the input stream switching flag to false (S249) and then ends a series of processes related to the “input stream switching process (FIGS. 23 to 25).”

So far, the details of the “input stream switching process (FIGS. 23 to 25)” have been described.

### (Details of “Packet Detailed Process (FIGS. 26 to 28)”)

Next, the details of the “packet detailed process (FIGS. 26 to 28)” will be described with reference to FIGS. 26 to 28. FIGS. 26 to 28 are explanatory diagrams for describing the details of the “packet detailed process (FIGS. 26 to 28).”

As illustrated in FIG. 26, the reproducing device 100 that has started the packet detailed process determines whether or not the number of packets to be written in the division stream file is an upper limit of the division section (S251). When the number of packets to be written in the division stream file is the upper limit of the division section, the reproducing device 100 causes the process to proceed to step S252. However, when the number of packets to be written in the division stream file is not the upper limit of the division section, the reproducing device 100 causes the process to proceed to step S254.

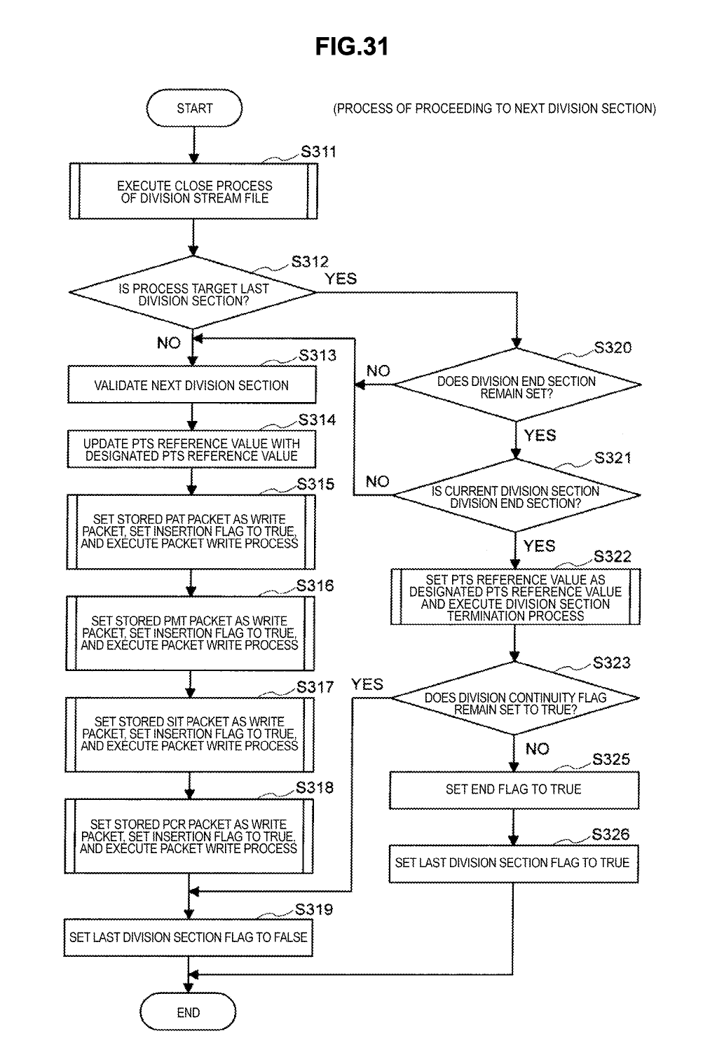

When the process has proceeded to step S252, the reproducing device 100 executes a “process of proceeding to a next division section (FIG. 31)” without designating a PTS reference value (S252). The details of the “process of proceeding to the next division section (FIG. 31)” will be described later. Next, the reproducing device 100 determines whether or not a last division section flag remains set to true (S253). When the last division section flag remains set to true, the reproducing device 100 ends a series of processes related to the “packet detailed process (FIGS. 26 to 28).” However, when the last division section flag remains set to false, the reproducing device 100 causes the process to proceed to step S254.

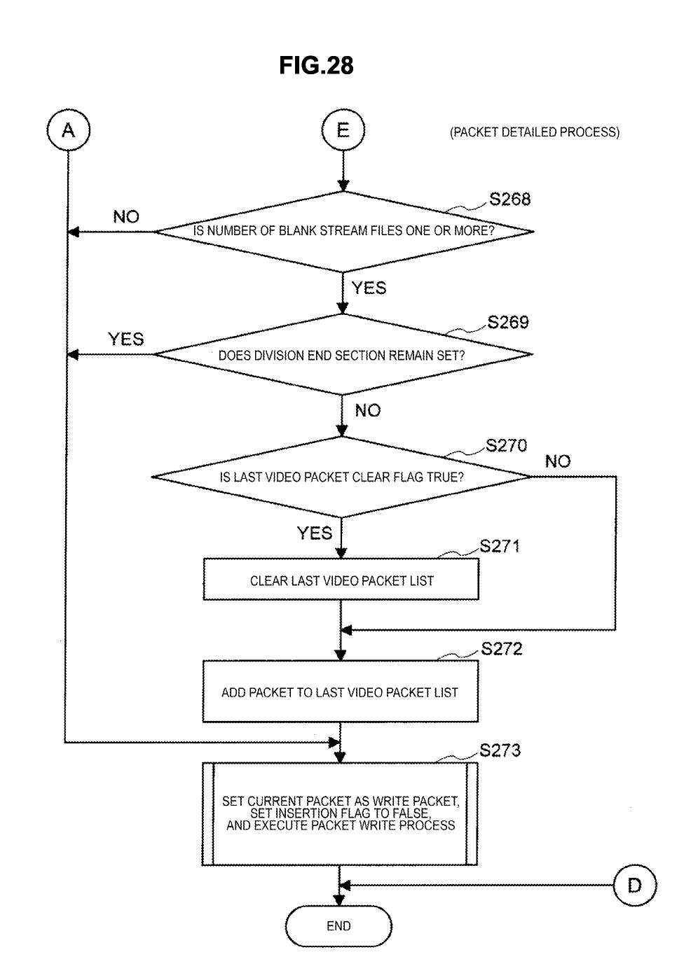

When the process has proceeded to step S254, the reproducing device 100 determines whether or not the process target is a video packet (S254). When the process target is a video packet, the reproducing device 100 causes the process to proceed to step S255. However, when the process target is not a video packet, the reproducing device 100 causes the process to proceed to step S273 (FIG. 28).

When the process has proceeded to step S255, the reproducing device 100 sets the last video packet clear flag to false (S255). Next, the reproducing device 100 determines whether or not the process target includes the DTS (S256). When the process target includes the DTS, the reproducing device 100 causes the process to proceed to step S257. However, when the process target does not include the DTS, the reproducing device 100 causes the process to proceed to step S268 (FIG. 28).

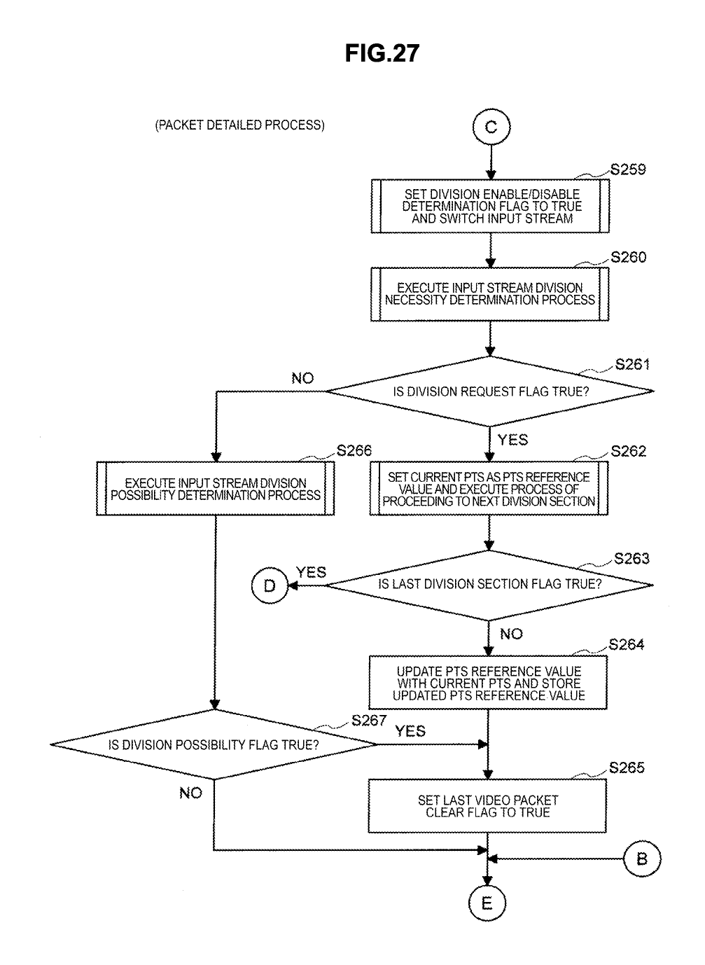

When the process has proceeded to step S257, the reproducing device 100 determines whether or not the PTS reference value remains set (S257). When the PTS reference value remains set, the reproducing device 100 causes the process to proceed to step S259 (FIG. 27). However, when the PTS reference value does not remain set, the reproducing device 100 updates the PTS reference value with the current PTS (S258).

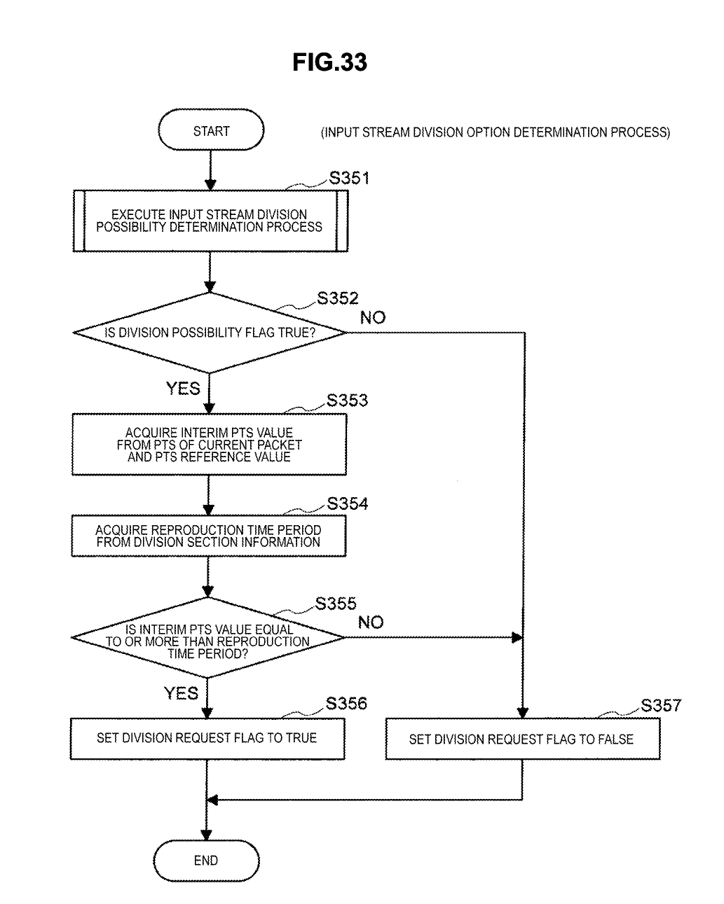

Next, referring to FIG. 27, the reproducing device 100 that has caused the process to proceed to step S259 sets the division enable/disable determination flag to true, and executes the “input stream switching process (FIGS. 23 to 25)” (S259). Next, the reproducing device 100 executes an “input stream division necessity determination process (FIG. 33)” (S260). The details of the “input stream division necessity determination process (FIG. 33)” will be described later.

Next, the reproducing device 100 determines whether or not a division request flag remains set to true (S261). When the division request flag remains set to true, the reproducing device 100 causes the process to proceed to step S262. However, when the division request flag remains set to false, the reproducing device 100 causes the process to proceed to step S266.

When the process has proceeded to step S262, the reproducing device 100 sets the current PTS as the PTS reference value, and executes the “process of proceeding to the next division section (FIG. 31)” (S262). The details of the “process of proceeding to the next division section (FIG. 31)” will be described later. Next, the reproducing device 100 determines whether or not the last division section flag remains set to true (S263). When the last division section flag remains set to true, the reproducing device 100 ends a series of processes related to the “packet detailed process (FIGS. 26 to 28).” However, when the last division section flag remains set to false, the reproducing device 100 causes the process to proceed to step S264.

When the process has proceeded to step S264, the reproducing device 100 updates the PTS reference value with the current PTS, and stores the PTS reference value (S264). Next, the reproducing device 100 sets the last video packet clear flag to true (S265), and then causes the process to proceed to step S268 (FIG. 28).

When the process has proceeded to step S266, the reproducing device 100 executes the “input stream division possibility determination process (FIG. 32)” (S266). The details of the “input stream division possibility determination process (FIG. 32)” will be described later. Next, the reproducing device 100 determines whether or not the division possibility flag remains set to true (S267). When the division possibility flag remains set to true, the reproducing device 100 causes the process to proceed to step S265. However, when the division possibility flag remains set to false, the reproducing device 100 causes the process to proceed to step S268 (FIG. 28).

Next, referring to FIG. 28, the reproducing device 100 that has caused the process to proceed to step S268 determines whether or not the number of blank stream files is one or more (S268). When the number of blank stream files is one or more, the reproducing device 100 causes the process to proceed to step S269. However, when the number of blank stream files is zero (0), the reproducing device 100 causes the process to proceed to step S273.

When the process has proceeded to step S269, the reproducing device 100 determines whether or not the division end section remains set (S269). When the division end section remains set, the reproducing device 100 causes the process to proceed to step S273. However, when the division end section does not remain set, the reproducing device 100 causes the process to proceed to step S270.

When the process has proceeded to step S270, the reproducing device 100 determines whether or not the last video packet clear flag remains set to true (S270). When the last video packet clear flag remains set to true, the reproducing device 100 causes the process to proceed to step S271. However, when the last video packet clear flag remains set to false, the reproducing device 100 causes the process to proceed to step S272.

When the process has proceeded to step S271, the reproducing device 100 clears the last video packet list (S271). Further, the reproducing device 100 that has caused the process to proceed to step S272 adds a packet to the last video packet list (S272). In addition, the reproducing device 100 that has caused the process to proceed to step S273 sets a current packet as a write packet, sets the insertion flag to false, and executes the “packet write process (FIGS. 29 and 30)” (S273). After executing the process of step S273, the reproducing device 100 ends a series of processes related to the “packet detailed process (FIGS. 26 to 28).”

So far, the details of the “packet detailed process (FIGS. 26 to 28)” have been described.

### (Details of “Packet Write Process (FIGS. 29 and 30)”)

Next, the details of the “packet write process (FIGS. 29 and 30)” will be described with reference to FIGS. 29 and 30. FIGS. 29 and 30 are explanatory diagrams for describing the details of the “packet write process (FIGS. 29 and 30).”

As illustrated in FIG. 29, the reproducing device 100 that has started the packet write process determines whether or not the division stream file remains opened (S291). When the division stream file remains opened, the reproducing device 100 causes the process to proceed to step S293. However, when the division stream file does not remain opened, the reproducing device 100 causes the process to proceed to step S292. When the process has proceeded to step S292, the reproducing device 100 acquires the output stream from the division stream file (S292).

The reproducing device 100 that has caused the process to proceed to step S293 acquires a start packet position of the division section (S293). Next, the reproducing device 100 determines whether or not the process target is any one of the PAT packet, the PMT packet, the SIT packet, and the PCR packet (S294). When the process target is any one of the PAT packet, the PMT packet, the SIT packet, and the PCR packet, the reproducing device 100 causes the process to proceed to step S295. However, when the process target is not any of the PAT packet, the PMT packet, the SIT packet, and the PCR packet, the reproducing device 100 causes the process to proceed to step S297 (FIG. 30).

When the process has proceeded to step S295, the reproducing device 100 determines whether or not the write position of the division stream file is the start packet position (S295). When the write position of the division stream file is the start packet position, the reproducing device 100 ends a series of processes related to the “packet write process (FIGS. 29 and 30).” However, when the write position of the division stream file is not the start packet position, the reproducing device 100 causes the process to proceed to step S296.

When the process has proceeded to step S296, the reproducing device 100 updates a continuity counter on a packet other than the PCR packet (S296), and then causes the process to proceed to step S300 (FIG. 30).

Next, referring to FIG. 30, when the process has proceeded to step S297, the reproducing device 100 determines whether or not the process target is a video packet (S297). When the process target is a video packet, the reproducing device 100 causes the process to proceed to step S298. However, when the process target is not a video packet, the reproducing device 100 causes the process to proceed to step S305.

When the process has proceeded to step S298, the reproducing device 100 determines whether or not the write packet position of the division stream file is the start packet position (S298). When the write packet position of the division stream file is the start packet position, the reproducing device 100 causes the process to proceed to step S300. However when the write packet position of the division stream file is not the start packet position, the reproducing device 100 causes the process to proceed to step S299.

When the process has proceeded to step S299, the reproducing device 100 sets the padding packet as the write packet, sets the insertion flag to true, and executes the “packet write process (FIG. 29)” (S299). In other words, the reproducing device 100 resets setting of the write packet and the insertion flag, and executes the process of step S291 and the subsequent processes. After executing the process of step S299, the reproducing device 100 causes the process to proceed to step S298.

When the process has proceeded to step S300, the reproducing device 100 updates the ATS of the packet with the current ATS (S300). Next, the reproducing device 100 determines whether or not the process target is a PCR packet (S301). When the process target is a PCR packet, the reproducing device 100 causes the process to proceed to step S302. However, when the process target is not a PCR packet, the reproducing device 100 causes the process to proceed to step S303.

When the process has proceeded to step S302, the reproducing device 100 updates the PCT of the packet with the current ATS (S302). The reproducing device 100 that has caused the process to proceed to step S303 updates the current ATS (S303). Next, the reproducing device 100 writes the packet in the output stream (S304), and then ends a series of processes related to the “packet write process (FIGS. 29 and 30).”

Further, when the process has proceeded to step S305, the reproducing device 100 determines whether or not the write position of the division stream file is ahead of the start packet position (S305). When the write position of the division stream file is ahead of the start packet position, the reproducing device 100 ends a series of processes related to the “packet write process (FIGS. 29 and 30).” However, when the write position of the division stream file is not ahead of the start packet position, the reproducing device 100 causes the process to proceed to step S300.

So far, the details of the “packet write process (FIGS. 29 and 30)” have been described.

Next, the “process of proceeding to the next division section (FIG. 31),” the “input stream division possibility determination process (FIG. 32),” and the “input stream division necessity determination process (FIG. 33),” which have been mentioned above, will be described in detail.

### (Details of “Process of Proceeding to Next Division Section (FIG. 31)”)

First, the details of the “process of proceeding to the next division section (FIG. 31)” will be described with reference to FIG. 31. FIG. 31 is an explanatory diagram for describing the details of the “process of proceeding to the next division section (FIG. 31).”

As illustrated in FIG. 31, the reproducing device 100 that has started the process of proceeding to the next division section executes the “division stream file close process (FIG. 21)” (S311). Next, the reproducing device 100 determines whether or not the process target is the last division section (S312). When the process target is the last division section, the reproducing device 100 causes the process to proceed to step S320. However, when the process target is not the last division section, the reproducing device 100 causes the process to proceed to step S313.

When the process has proceeded to step S313, the reproducing device 100 validates the next division section (S313). Next, the reproducing device 100 updates the PTS reference value with a designated PTS reference value (S314). Next, the reproducing device 100 sets the stored PAT packet as the write packet, sets the insertion flag to true, and executes the “packet write process (FIGS. 29 and 30)” (S315). Next, the reproducing device 100 sets the stored PMT packet as the write packet, sets the insertion flag to true, and executes the “packet write process (FIGS. 29 and 30)” (S316).

Next, the reproducing device 100 sets the stored SIT packet as the write packet, sets the insertion flag to true, and executes the “packet write process (FIGS. 29 and 30)” (S317). Next, the reproducing device 100 sets the stored PCR packet as the write packet, sets the insertion flag to true, and executes the “packet write process (FIGS. 29 and 30)” (S318). Next, the reproducing device 100 sets the last division section flag to false (S319), and then ends a series of processes related to the “process of proceeding to the next division section (FIG. 31).”

Further, when the process has proceeded to step S320, the reproducing device 100 determines whether or not the division end section remains set (S320). When the division end section remains set, the reproducing device 100 causes the process to proceed to step S321. However, when the division end section does not remain set, the reproducing device 100 causes the process to proceed to step S313.

When the process has proceeded to step S321, the reproducing device 100 determines whether or not the current division section is the division end section (S321). When the current division section is the division end section, the reproducing device 100 causes the process to proceed to step S322. However, when the current division section is not the division end section, the reproducing device 100 causes the process to proceed to step S313.

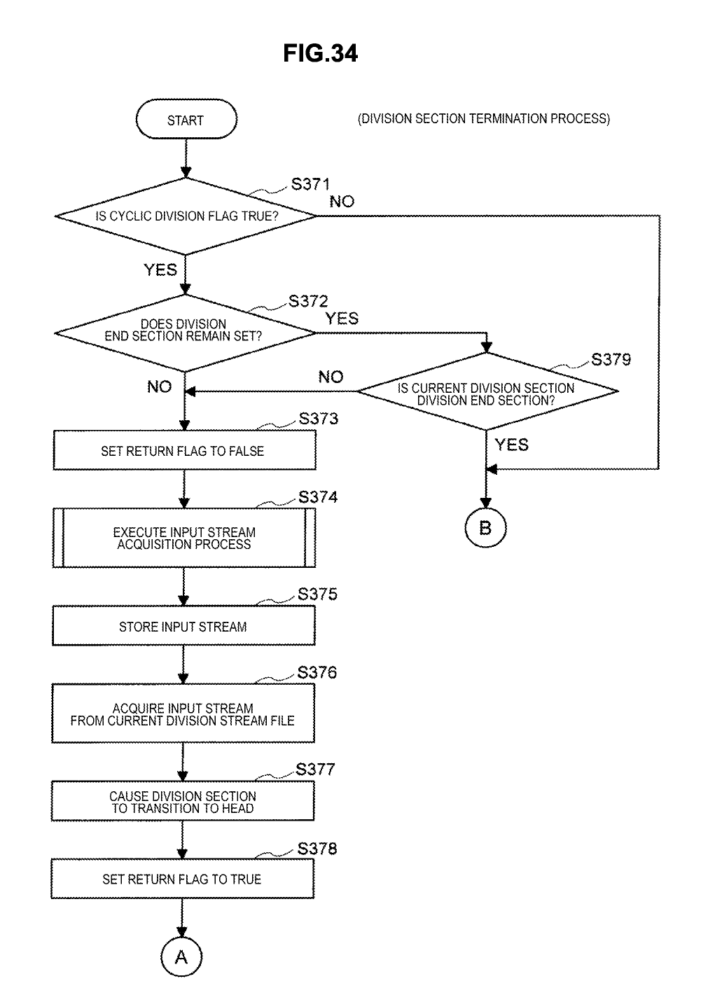

When the process has proceeded to step S322, the reproducing device 100 sets the PTS reference value as a designated PTS reference value, and executes a “division section termination process (FIGS. 34 to 36)” (S322). The details of the “division section termination process (FIGS. 34 to 36)” will be described later. Next, the reproducing device 100 determines whether or not the division continuity flag remains set to true (S323). When the division continuity flag remains set to true, the reproducing device 100 causes the process to proceed to step S319. However, when the division continuity flag remains set to false, the reproducing device 100 causes the process to proceed to step S325.

When the process has proceeded to step S325, the reproducing device 100 sets the end flag to true (S325). Next, the reproducing device 100 sets the last division section flag to true (S326), and then ends a series of processes related to the “process of proceeding to the next division section (FIG. 31).” Further, when the process has proceeded to step S319, the reproducing device 100 sets the last division section flag to false (S319), and then ends a series of processes related to the “process of proceeding to the next division section (FIG. 31).”

So far, the details of the “process of proceeding to the next division section (FIG. 31)” have been described.

### (Details of “Input Stream Division Possibility Determination Process (FIG. 32)”)

Next, the details of the “input stream division possibility determination process (FIG. 32)” will be described with reference to FIG. 32. FIG. 32 is an explanatory diagram for describing the details of the “input stream division possibility determination process (FIG. 32).”

As illustrated in FIG. 32, the reproducing device 100 that has started the input stream division possibility determination process acquires a video codec from the division section information (S331). Next, the reproducing device 100 determines whether or not the division process can be performed based on information related to the current packet and information related to the video codec (S332). Then, the reproducing device 100 switches the process based on the determination result (S333). When the division process can be performed, the reproducing device 100 causes the process to proceed to step S334. However, when it is difficult to perform the division process, the reproducing device 100 causes the process to proceed to step S335.

When the process has proceeded to step S334, the reproducing device 100 sets the division possibility flag to true (S334), and then ends a series of processes related to the “input stream division possibility determination process (FIG. 32).” Further, when the process has proceeded to step S335, the reproducing device 100 sets the division possibility flag to false (S335), and then ends a series of processes related to the “input stream division possibility determination process (FIG. 32).”

So far, the details of the “input stream division possibility determination process (FIG. 32)” have been described.

### (Details of “Input Stream Division Necessity Determination Process (FIG. 33)”)

Next, the details of the “input stream division necessity determination process (FIG. 33)” will be described with reference to FIG. 33. FIG. 33 is an explanatory diagram for describing the details of the “input stream division necessity determination process (FIG. 33).”

As illustrated in FIG. 33, the reproducing device 100 that has started the input stream division necessity determination process executes the “input stream division possibility determination process (FIG. 32)” (S351). Then, the reproducing device 100 determines whether or not the division possibility flag remains set to true (S352). When the division possibility flag remains set to true, the reproducing device 100 causes the process to proceed to step S353. However, when the division possibility flag remains set to false, the reproducing device 100 causes the process to proceed to step S357.

When the process has proceeded to step S353, the reproducing device 100 acquires an interim PTS value based on the PTS of the current packet and the PTS reference value (S353). Next, the reproducing device 100 acquires the reproduction time period from the division section information (S354). Next, the reproducing device 100 determines whether or not the interim PTS value is equal to or more than the reproduction time period (S355). When the interim PTS value is equal to or more than the reproduction time period, the reproducing device 100 causes the process to proceed to step S356. However, when the interim PTS value is less than the reproduction time period, the reproducing device 100 causes the process to proceed to step S357.

When the process has proceeded to step S356, the reproducing device 100 sets the division request flag to true (S356), and then ends a series of processes related to the “input stream division necessity determination process (FIG. 33).” However, when the process has proceeded to step S357, the reproducing device 100 sets the division request flag to false (S357), and then ends a series of processes related to the “input stream division necessity determination process (FIG. 33).”

So far, the details of the “input stream division necessity determination process (FIG. 33)” have been described.

Next, the details of the above-mentioned “division section termination process (FIGS. 34 to 36)” will be described.

### (Details of “Division Section Termination Process (FIGS. 34 to 36)”)

Next, the details of the “division section termination process (FIGS. 34 to 36)” will be described with reference to FIGS. 34 to 36. FIGS. 34 to 36 are explanatory diagrams for describing the details of the “division section termination process (FIGS. 34 to 36).”

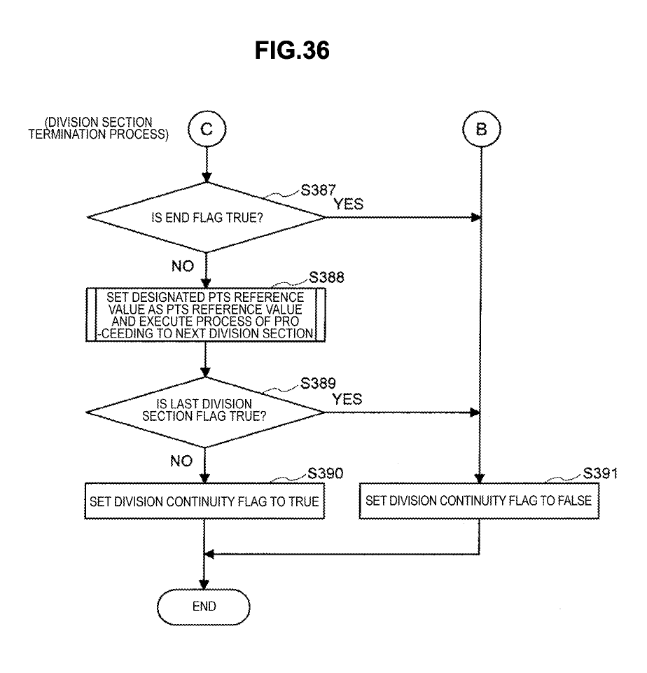

As illustrated in FIG. 34, the reproducing device 100 that has started the division section termination process determines whether or not the cyclic division flag remains set to true (S371). When the cyclic division flag remains set to true, the reproducing device 100 causes the process to proceed to step S372. However, when the cyclic division flag remains set to false, the reproducing device 100 causes the process to proceed to step S391 (FIG. 36).

When the process has proceeded to step S372, the reproducing device 100 determines whether or not the division end section remains set (S372). When the division end section remains set, the reproducing device 100 causes the process to proceed to step S379. However, when the division end section remains set, the reproducing device 100 causes the process to proceed to step S373.

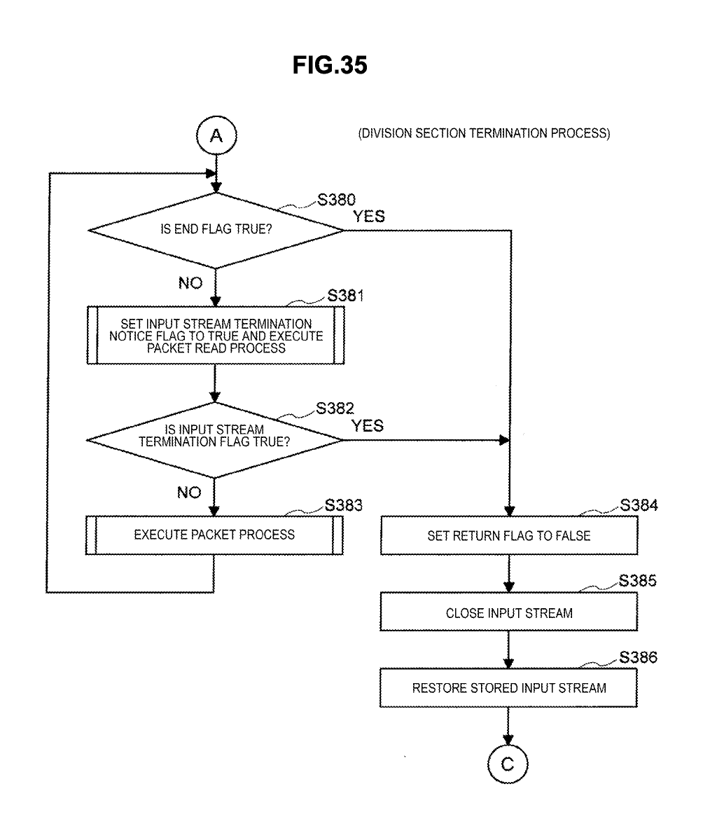

When the process has proceeded to step S373, the reproducing device 100 sets the return flag to false (S373). Next, the reproducing device 100 executes the “input stream acquisition process (FIG. 22)” (S374). Next, the reproducing device 100 stores the input stream (S375). Next, the input stream is acquired from the current division stream file (S376). Next, the reproducing device 100 causes the division section to transition to the head (S377). Next, the reproducing device 100 sets the return flag to true (S378), and causes the process to proceed to step S380 (FIG. 35).

Further, when the process has proceeded to step S379, the reproducing device 100 determines whether or not the current division section is the division end section (S379). When the current division section is the division end section, the reproducing device 100 causes the process to proceed to step S391 (FIG. 36). However, when the current division section is not the division end section, the reproducing device 100 causes the process to proceed to step S373.

Next, referring to FIG. 35, the reproducing device 100 that has caused the process to proceed to step S380 determines whether or not the end flag remains set to true (S380). When the end flag remains set to true, the reproducing device 100 causes the process to proceed to step S384. However, when the end flag remains set to false, the reproducing device 100 causes the process to proceed to step S381.

When the process has proceeded to step S381, the reproducing device 100 sets the input stream termination notice flag to true, and executes the “packet read process (FIGS. 15 and 16)” (S381). Next, the reproducing device 100 determines whether or not the input stream termination flag remains set to true (S382). When the input stream termination flag remains set to true, the reproducing device 100 causes the process to proceed to step S384. However, when the input stream termination flag remains set to false, the reproducing device 100 causes the process to proceed to step S383.

When the process has proceeded to step S383, the reproducing device 100 executes the “packet process (FIGS. 17 to 19)” (S383), and then causes the process to proceed to step S380. Further, when the process has proceeded to step S384, the reproducing device 100 sets the return flag to false (S384). Next, the reproducing device 100 closes the input stream (S385). Next, the reproducing device 100 restores the stored input stream (S386), and causes the process to proceed to step S387 (FIG. 36).

Next, referring to FIG. 36, the reproducing device 100 that has caused the process to proceed to step S387 determines whether or not the end flag remains set to true (S387). When the end flag remains set to true, the reproducing device 100 causes the process to proceed to step S391. However, when the end flag remains set to false, the reproducing device 100 causes the process to proceed to step S388.

When the process has proceeded to step S388, the reproducing device 100 sets the designated PTS reference value as the PTS reference value, and executes the “process of proceeding to the next division section (FIG. 31)” (S388). Next, the reproducing device 100 determines whether or not the last division section flag remains set to true (S389). When the last division section flag remains set to true, the reproducing device 100 causes the process to proceed to step S391. However, when the last division section flag remains set to false, the reproducing device 100 causes the process to proceed to step S390.

When the process has proceeded to step S390, the reproducing device 100 sets the division continuity flag to true (S390), and then ends a series of processes related to the “division section termination process (FIGS. 34 to 36).” Further, when the process has proceeded to step S391, the reproducing device 100 sets the division continuity flag to false (S391), and then ends a series of processes related to the “division section termination process (FIGS. 34 to 36).”

So far, the details of the “division section termination process (FIGS. 34 to 36)” have been described.

So far, the flow of the progressive download reproduction process executed by the reproducing device 100 according to the present embodiment has been described.

### [2-3: Supplement]

Next, a supplemental description will be made.

### (Application to Variable Bit Rate Reproduction)

An application to variable bit rate reproduction may be implemented in the following way. When a decrease in a download speed is detected, the reproducing device 100 starts switching to a stream file with a low bit rate. First, the reproducing device 100 transmits a current download speed and time information of an access unit head to the distribution server 11. The distribution server 11 that has transmitted the above information selects a stream file of an appropriate bit rate. Then, the distribution server 11 sets a download start position, and causes the selected stream file to be downloaded to the reproducing device 100.

An interval of an access unit included in the stream file is much shorter than the division section of the reproduction management file. For this reason, it is possible to switch the stream file at a high speed. When a stream file of an appropriate bit rate is selected, the distribution server 11 may transmit only the time information of the access unit head. In this case, the reproducing device 100 needs to prepare download information corresponding to various bit rates in advance.

### (Application to Interrupt Reproduction)

In the variable bit rate reproduction, switching to a stream file which is the same in content but different in a bit rate is performed. However, when conditions such as a codec and a bit rate are the same, switching to a stream file with the same content can be also performed. Thus, an application to interrupt reproduction can be made.

### (Application to CM Insertion or the Like)

In the variable bit rate reproduction, switching of a stream file is performed on a head of an access unit positioned directly after a time when the switching request is received. However, by designating a switching request and a switching request time, switching of a stream may be performed on a head of an access unit positioned directly after the switching request time. As a result, any other stream file can be reproduced during a predetermined time period when reproduction of a stream file starts. The number of other stream files may be plural.

### (Reduction in Division Number and Reproduction Start Standby Time)

When a division number of a stream file increases, it may affect a reproduction performance of the BD player. For this reason, it is desirable that a division section be as long as possible. Many BD players perform pre-fetching of a division file at the time of reproduction start and during reproduction. For example, when a BD player in which the number of pre-fetch division files is 3 is used, reproduction does not start until 3 division files become available.

In this regard, the inventor(s) has/have studied a method for realizing a reduction in the reproduction start standby time while reducing the division number and so found the following method for gradually elongating a division section. For example, when the number of pre-fetch division files is assumed to be 3, if a division section is elongated for every 3 division files, the reproduction start standby time can be reduced while reducing the division number. A degree of elongating the division section is preferably decided according to an expected value of a download speed.

For example, when it is assumed that a first division section is set to 3 seconds and it takes 0.8 seconds to download a stream file of 1 second, a column of division sections is as follows:

### 3, 3, 3, 3.750, 3.750, 3.750, 4,687, 4.687, 4.687,—(unit: seconds)

The above column represents that when a fourth division section is downloaded, reproduction can start from a first division section, and a stream file of 3.750 seconds can be downloaded during reproduction of 3 seconds. Further, the above column represents that when a seventh division section is downloaded, a fourth division section can be reproduced, and a stream file of 4.687 seconds can be downloaded during reproduction of 3.750 seconds. When division is continuously performed based on this rule, a division number is 72, and it is possible to deal with stream files of 3 hours or more.

### (Response to Stream Files Fewer Than Division Number of Reproduction Management File)

As described above, many BD players perform pre-fetching of a division file. For this reason, when the number of division files is less than a division number of the reproduction management file, an error representing data deficiency is generated at a point in time when a pre-fetching position reaches beyond a last division file. As a method of avoiding this error, for example, a method may be used in which last video data of a stream file is stored, and after division ends, division files which are equal in number to the number of pre-fetch division files are automatically added using this data. Through this method, the stream file can be reproduced up to the termination point.

### (Implementation of Scene Jump)

As a method of jumping a reproduction position in a head direction, a method may be used in which a reproduced division file is left, and movement to a corresponding position is performed. However, a storage capacity of the BD player is not much. For this reason, it is desirable to delete a reproduced division file immediately. In this regard, the inventor(s) has/have studied a method capable of implementing scene jumping even when there is no division file of a movement destination.

The BD player performs pre-etching of a division file. For this reason, a standby time occurs between when downloading of the stream file in which a download start position is set as a scene jump destination starts and when reproduction starts. As a method of avoiding the standby time, for example, a method may be used in which, at the time of scene jump, a division section returns to the head, and downloading starts from the scene jump position. Through this method, scene jump can be implemented while keeping the shortest standby time. An original reproduction time may be calculated by adding a reproduction time to a time when scene jump is performed.

(Management of Stream File and Easy Transition from Download-Type Service)

The reproducing device 100 according to the present embodiment appropriately divides a stream file based on a predetermined reproduction management file. For this reason, a stream file supplied to the reproducing device 100 need not be divided in advance. As a result, it is possible to suppress the number of stream files stored in the distribution server 11 to be minimum. Further, a stream file of a batch download-type service may be used as is. For this reason, transition from a batch download-type service to a progressive download-type service can be easily performed.

### (Implementation of Live Camera Relay)

A method may be used in which a plurality of stream files are combined, and then a combined stream file is divided again based on a predetermined reproduction management file. For example, a live camera relay may be implemented such that a moving image and audio captured by a live camera and a microphone are sequentially uploaded to the distribution server 11 in the form of a file of a small size, and then the uploaded moving image and audio are downloaded and reproduced sequentially from a new one. Further, when a codec or a bit rate of a captured moving image and sound conforms to the BD standard, the captured moving image and sound may be uploaded in the MPEG2-TS format and then may be converted into M2TS at the time of download. In addition, when there is a transcoder for generating an MPEG2-TS, reproducible content is not limited to one captured by a live camera.

So far, the description has been supplemented.

### 3: Hardware Configuration Example

The functions of the respective components included in the reproducing device 100 may be implemented, for example, using some or all of hardware components illustrated in FIG. 37. In other words, the function of each component is implemented by controlling hardware illustrated in FIG. 37 using a computer program. The form of the hardware is arbitrary, and examples of the hardware may include a portable information terminal such as a personal computer, a portable telephone, a PHS, and a PDA, a game machine, and various information appliances. Here, PHS stands for “personal handy-phone system.” PDA stands for “personal digital assistant.”

As illustrated in FIG. 37, the hardware mainly includes a CPU 902, a ROM 904, a RAM 906, a host bus 908, and a bridge 910. The hardware further includes an external bus 912, an interface 914, an input unit 916, an output unit 918, a storage unit 920, a drive 922, a connection port 924, and a communication unit 926. CPU stands for “central processing unit.” ROM stands for “read only memory.” RAM stands for “random access memory.”

The CPU 902 functions as, for example, an arithmetic processing unit or a control device, and controls general or partial operations of the respective components based on various programs recorded in the ROM 904, the RAM 906, the storage unit 920, or a removable recording medium 928. The ROM 904 is a means for storing a program read by the CPU 902 or data used for a calculation. For example, the RAM 906 temporarily or permanently stores a program read by the CPU 90 or various parameters that appropriately change when the program is executed.

For example, the components are connected to one another via the host bus 908 that allows high-speed data transmission. For example, the host bus 908 is connected to the external bus 912 having a relatively low data transmission rate via the bridge 910. For example, a mouse, a keyboard, a touch panel, a button switch, a lever, and the like are used as the input unit 916. Further, a remote controller (hereinafter, “remote”), which transmits a control signal using an infrared ray (IR) or another radio wave, may be used as the input unit 916.

Examples of the output unit 918 include a display device such as a CRT, an LCD, a PDP, or an ELD, an audio output device such as a speaker or a headphone, a printer, a portable telephone, and a facsimile. The output unit 918 notifies the user of the acquired information visually or auditorily. CRT stands for “cathode ray tube.” LCD stands for “liquid crystal display.” PDP stands for “plasma display panel.” ELD stands for “electro-luminescence display.”

The storage unit 920 is a device for storing various data. Examples of the storage unit 920 include a magnetic storage device such as an HDD, a semiconductor memory device, an optical storage device, and a magneto-optical memory device. HDD stands for “hard disk drive.”

For example, the drive 922 is a device that reads information stored in the removable recording medium 928 such as a magnetic disk, an optical disc, a magneto-optical disc, or a semiconductor memory and writes information in the removable recording medium 928. Examples of the removable recording medium 928 include a digital versatile disc (DVD) medium, a Blu-ray medium, an HD DVD medium, and various semiconductor storage medium. Of course, for example, the removable recording medium 928 may include an IC card in which a non-contact type IC chip is mounted, an electronic device, or the like. IC stands for an “integrated circuit.”

Examples of the connection port 924 include a USB port, an IEEE 1394 port, an SCSI, an RS-232C port, or an optical audio terminal, and the connection port 924 is connected to an external connection device 930. Examples of the external connection device 930 include a printer, a portable music player, a digital camera, a digital video camera, or an IC recorder. USB stands for “universal serial bus.” SCSI stands for “mall computer system interface.”

The communication unit 926 is a communication device that enables a connection to a network 932. Examples of the communication unit 926 include a wired or wireless LAN, Bluetooth (a registered trademark), or a WUSB communication card, an optical communication router, an ADSL router, and various communication modems. The network 932 connected to the communication unit 926 is configured with a network connected in a wired manner or a wireless manner. Examples of the network 932 include the Internet, a home LAN, IR communication, visible light communication (VLC), broadcasting, and satellite communication. LAN stands for “local area network.” WUSB stands for “wireless USB.” ADSL stands for “asymmetric digital subscriber line.”

### 4: Summary

Lastly, the technical spirit of the present embodiment will be briefly summarized. The technical spirit described below is not limited to a reproducing device such as the BD player but may be applied to various information processing devices with a function of a reproducing device such as a PC, a portable telephone, a portable game machine, a portable information terminal, an information appliance, or a car navigation system.

Additionally, the present technology may also be configured as below. For example, the reproducing device according to claim 1 is configured to divide a stream file obtained to generate a division stream file. The reproducing device executes a division processing so that the stream file to be divided fits a predetermined play list and a predetermined clip information file. Therefore, the division stream file generated by the reproducing device may be generated based on the predetermined play list and the predetermined clip information file.

In other words, as far as the reproducing device recognizes the predetermined play list and the predetermined clip information file in advance, it is possible to generate any arbitrary stream file without executing recognition of the play list and the clip information file. For that reason, even when reproducing new contents, it is possible to quickly reproduce stream files. Moreover, since reproducing can be controlled over a division stream file, which is shorter than the stream file to be obtained, as a unit, it is possible to switch stream files to be obtained during obtaining stream files.

(1) A reproducing device, including:

a stream acquiring unit that acquires a stream file;

a stream dividing unit that divides the stream file to be appropriate for a predetermined play list and a predetermined clip information file and generates a division stream file; and

a stream reproducing unit that reproduces the division stream file based on the predetermined play list and the predetermined clip information file.

(2) The reproducing device according to (1), wherein the stream dividing unit adds (n−m) padding packets to the division stream file when the number n of packets described in the predetermined clip information file is larger than the number m of packets included in the division stream file.

(3) The reproducing device according to (1) or (2), further including:

a blank stream generating unit that generates a blank stream file configured with a packet positioned at a tail end of the stream file; and

a blank stream adding unit that adds, to the blank stream file, a predetermined number of blank stream files necessary to cause a sum of reproduction time periods to be longer than a reproduction time period tp of the predetermined play list when a reproduction time period ts is shorter than the reproduction time period tp.

(4) The reproducing device according to any one of (1) to (3), further including

a division section information generating unit that generates division section information used for generation of the division stream file based on each play item included in the predetermined play list and the predetermined clip information file corresponding to each play item,

wherein the stream dividing unit generates the division stream file based on the division section information, and

the division section information includes a reproduction start time, a reproduction finish time, a position of start packet, and the number of packets included in the division stream file.

(5) The reproducing device according to any one of (1) to (4), wherein when N play items are included in the predetermined play list and the reproduction time period ts of the stream file is longer than the reproduction time period tp of the predetermined play list,

the division section information generating unit generates first to N-th division section information which corresponds to first to N-th play items, respectively, and the stream dividing unit generates first to N-th division stream files using the first to N-th division section information and then generates an (N+1)-th division stream file and subsequent division stream files using the first division section information and subsequent division section information.

(6) The reproducing device according to any one of (1) to (5), wherein the stream acquiring unit switches a stream file to be acquired according to a communication rate when the stream file is acquired via a communication line.

(7) The reproducing device according to (4), wherein the division section information generating unit generates the division section information such that the reproduction time period of the division stream file increases in a stepwise manner as a reproduction time becomes later.

(8) A method of generating a stream file, including:

acquiring a stream file;

dividing the stream file to be appropriate for a predetermined play list and a predetermined clip information file and generating a division stream file; and

reproducing the division stream file based on the predetermined play list and the predetermined clip information file.

(9) A program for causing a computer to execute:

a stream acquiring function of acquiring a stream file;

a stream dividing function of dividing the stream file to be appropriate for a predetermined play list and a predetermined clip information file and generating a division stream file; and

a stream reproducing function of reproducing the division stream file based on the predetermined play list and the predetermined clip information file.

### (Remarks)

The communication unit 101 is an example of a stream acquiring unit. The stream file selecting/dividing unit 102 is an example of a stream dividing unit, a blank stream generating unit, and a blank stream adding unit. The reproduction control unit 103 is an example of a stream reproducing unit. The reproduction management file analyzing unit 104 is an example of a division section information generating unit.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-110309 filed in the Japan Patent Office on May 17, 2011, the entire content of which is hereby incorporated by reference.

What is claimed is:

1. A reproducing device, comprising:
a stream acquiring unit that acquires a stream file;
a stream dividing unit that divides the stream file to be appropriate for a predetermined play list and a predetermined clip information file and generates a division stream file; and
a stream reproducing unit that reproduces the division stream file based on the predetermined play list and the predetermined clip information file.

2. The reproducing device according to claim 1, wherein the stream dividing unit adds (n−m) padding packets to the division stream file when the number n of packets described in the predetermined clip information file is larger than the number m of packets included in the division stream file.

3. The reproducing device according to claim 2, further comprising:
a blank stream generating unit that generates a blank stream file configured with a packet positioned at a tail end of the stream file; and
a blank stream adding unit that adds, to the blank stream file, a predetermined number of blank stream files necessary to cause a sum of reproduction time periods to be longer than a reproduction time period tp of the predetermined play list when a reproduction time period is shorter than the reproduction time period tp.

4. The reproducing device according to claim 3, further comprising
a division section information generating unit that generates division section information used for generation of the division stream file based on each play item included in the predetermined play list and the predetermined clip information file corresponding to each play item,
wherein the stream dividing unit generates the division stream file based on the division section information, and
the division section information includes a reproduction start time, a reproduction finish time, a position of start packet, and the number of packets included in the division stream file.

5. The reproducing device according to claim 4, wherein when N play items are included in the predetermined play list and the reproduction time period is of the stream file is longer than the reproduction time period tp of the predetermined play list,
the division section information generating unit generates first to N-th division section information which corresponds to first to N-th play items, respectively, and
the stream dividing unit generates first to N-th division stream files using the first to N-th division section information and then generates an (N+1)-th division stream file and subsequent division stream files using the first division section information and subsequent division section information.

6. The reproducing device according to claim 1, wherein the stream acquiring unit switches a stream file to be acquired according to a communication rate when the stream file is acquired via a communication line.

7. The reproducing device according to claim 4, wherein the division section information generating unit generates the division section information such that the reproduction time period of the division stream file increases in a stepwise manner as a reproduction time becomes later.

8. A method of generating a stream file, comprising:
acquiring a stream file;
dividing the stream file to be appropriate for a predetermined play list and a predetermined clip information file and generating a division stream file; and
reproducing the division stream file based on the predetermined play list and the predetermined clip information file.

9. A program for causing a computer to execute:
a stream acquiring function of acquiring a stream file;
a stream dividing function of dividing the stream file to be appropriate for a predetermined play list and a predetermined clip information file and generating a division stream file; and
a stream reproducing function of reproducing the division stream file based on the predetermined play list and the predetermined clip information file.
